(19) United States
(12) Patent Application Publication
(10) Pub. No.: US 2026/0095052 A1
(43) Pub. Date: Apr. 2, 2026

(54) MULTI-OPERATIONAL MODE INVERTERS THAT FACILITATE A UNIFIED CONTROL DESIGN ACROSS DIFFERENT POWER GRID TYPES

(71) Applicant: The Board of Trustees of the University of Illinois, Urbana, IL (US)

(72) Inventors: Srinivasa M. Salapaka, Champaign, IL (US); Alireza Askarian, Mahomet, IL (US); Jaesang Park, Urbana, IL (US)

(21) Appl. No.: 19/342,106

(22) Filed: Sep. 26, 2025

Related U.S. Application Data
(60) Provisional application No. 63/699,962, filed on Sep. 27, 2024.

(51) Int. Cl. H02J 3/38; H02J 3/40

(52) U.S. Cl. CPC H02J 3/381; H02J 3/40; H02J 2103/30; H02J 2103/35

(57) ABSTRACT

A computing system for functional integration with a distributed power grid having one or more inverters. The computing system includes processing device(s) to control operation of an inverter by executing a feedback controller with a grid-tied line, of the distributed power grid, treated as a plant and including a unified algebraic control system operating based on a pair of closed-loop variables carried in closed-loop signals of the unified algebraic control system. The processing device(s) control, using the feedback controller, transitions of the inverter between a plurality of operating modes by adjusting a magnitude of the closed-loop signals, which correspond to the pair of closed-loop variables, towards a setpoint of a plurality of setpoints. Each setpoint corresponds to a different operating mode of the plurality of operating modes.

### TECHNICAL FIELD

Embodiments of the disclosure relate generally to power inverters, and more specifically, relate to multi-operational mode inverters that facilitate a unified control design across different power grid types.

### BACKGROUND

Inverters with rapid response times and advanced digital processing capabilities are employed for large-scale integration of renewable distributed energy resources (DERs) into a multi-source power grid, managing significant spatio-temporal variations and inherent uncertainties of renewables. Significant progress has been made in inverter control methods, enabling renewable energy integration and dynamic adjustments based on grid conditions, load demand, and energy availability.

### BRIEF DESCRIPTION OF THE DRAWINGS

A more particular description of the disclosure briefly described above will be rendered by reference to the appended drawings. Understanding that these drawings only provide information concerning typical embodiments and are not therefore to be considered limiting of its scope, the disclosure will be described and explained with additional specificity and detail through the use of the accompanying drawings.

FIG. 1 is an operational schematic diagram illustrating a collection of inverter units to assimilate distributed energy resource and storage units into a power grid according to some embodiments.

FIG. 2A is a circuit diagram illustrating an inverter as a controlled voltage source, v_{c}, connected to the power grid, v_{g}, via an resistor-inductor (RL) impedance according to various embodiments.

FIG. 2B is a graph of dq synchronous rotating frame associated with FIG. 2A according to some embodiments.

FIG. 3 is a circuit diagram illustrating a proposed closed-loop with line dynamics G_{L} in Equation (4) as plant and K=\tilde{K}K_{L} as a multiple input, multiple output (MIMO) feedback controller according to some embodiments.

FIG. 4A, FIG. 4B, FIG. 4C, FIG. 4D are Bode plots illustrating inverter operating mode based on the shape and number of zeros in S at low-frequency in, respectively: (a) grid-forming (GFM); (b) voltage support in static synchronous compensator (STATCOM); (c) frequency support in an energy storage system (ESS); and (d) grid-following (GFL).

FIG. 5 is a continuum representation of a spectrum between GFL and VSI parameterized by \tilde{S} according to some embodiments.

FIG. 6 is a Bode plot illustrating operations of desired q-axis closed-loops Tᵥ, T_{θ}, \tilde{T}^{q}, and corresponding open-loops

$${K}_{1}^{q} {\tilde{G}}_{M} , {K}_{2}^{q} {\tilde{G}}_{M}$$

ana K^{q}\tilde{G}_{M} according to some embodiments.

FIG. 7 is a Bode plot illustrating smaller values of λ, which impose stricter upper-bounds on sensitivity around the fundamental frequency ω_{θ} according to at least one embodiment.

FIG. 8A and FIG. 8B are circuit diagrams illustrating, respectively, (a) nested structure with voltage and current inputs; and (b) inverter closed-loop as part of feedback compensator.

FIG. 9 is multi-dimensional graph illustrating operating space of a multi-operational mode power grid parameterized by (κᵥ, κ_{θ}) according to some embodiments.

FIG. 10A, FIG. 10B, FIG. 10C, and FIG. 10D are graphs of current over time during nominal grid operation, respectively: (a) active current with and without set-point adjustment; (b) reactive current in a complex line scenario; (c) active current with adjusted current set-point; and (d) reactive current in inductive line scenario according to various embodiments.

FIG. 11A, FIG. 11B, FIG. 11C, FIG. 11D are graphs of current over time during disturbed grid operation, respectively: (a) active current with and without set-point adjustment under grid frequency disturbance; (b) reactive current deviation under grid volage disturbance; (c) improving active current with adjusted current set-point; and (d) improving reactive current in inductive line scenario by decreasing the sensitivity transfer function according to various embodiments.

FIG. 12 is a graph of a frequency response of the inverter to step change of magnitude 0.1 hertz (Hz) in grid frequency according to at least one embodiment.

FIG. 13 is a set of graphs illustrating how a proposed GFM control system effectively rejects a 120 Hz ripple caused by line-to-ground fault on inverter current and frequency according at least one embodiment.

FIG. 14A, FIG. 14B, FIG. 14C, FIG. 14D are graphs illustrating, respectively, d-axis current, q-axis current, inverter voltage, and inverter frequency of a seamless transition of the set of inverters during on-grid operation at particular moments outline in Table III according to some embodiments.

FIG. 15A, FIG. 15B, FIG. 15C are graphs illustrating, respectively, (a) a Bode plot for d-axis and q-axis open-loops under GFM and GFL operation; (b) GFM response to step-change in active current set-point under line impedance variation; and (c) GFL response to step-change in active current set-point under line impedance variation according to some embodiments.

FIG. 16A, FIG. 16B, FIG. 16C, FIG. 16D are graphs illustrating, respectively, d-axis current, q-axis current, inverter voltage, and inverter frequency of a seamless transition of the set of inverters during on-grid operation at particular moments outline in Table IV according to some embodiments.

FIG. 17A is a control diagram of a three-phase phase-locked loop (PLL) system for GFL inverters according to some embodiments.

FIG. 17B is a control diagram of modified frequency control for GFN inverters to mimic rotor dynamic and governor action according to some embodiments.

FIG. 18 is a graph of Bode plots for five key transfer functions in the q-axis and their corresponding open-loop transfer functions according to some embodiments.

FIG. 19A is a circuit diagram of a three-phase DC/AC inverter with sensor measurements for feedback control according to some embodiments.

FIG. 19B is a control diagram representation of the embedded implementation of the feedback controller according to some embodiments.

FIG. 20A is a graph of an inverter's output current magnitude as a function of grid voltage deviation (Δv) and frequency deviation (Δω) according to an embodiment.

FIG. 20B is a 2D cross-section of the surface in FIG. 20A along the i′^{q}=0 plane according to an embodiment.

FIG. 20C is a 2D cross-section of the surface in FIG. 20A along the i′^{d}=0 plane according to an embodiment.

FIG. 21 illustrates a block diagram illustrating an exemplary computer device (or computing device), in accordance with implementations of the present disclosure.

While embodiments of the present disclosure are susceptible to various modifications and alternative forms, exemplary embodiments thereof are shown by way of example in the drawings and are herein described in detail. It should be understood, however, that the description of exemplary embodiments is not intended to limit the disclosure to the particular forms disclosed, but on the contrary, the intention is to cover all modifications, equivalents and alternatives falling within the spirit and scope of the in accordance with one or more embodiments of the present disclosure.

### DETAILED DESCRIPTION

The technology now will be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements.

Likewise, many modifications and other embodiments of the technology described herein will come to mind to one of skill in the art to which the disclosure pertains having the benefit of the teachings presented in the enclosed descriptions and the associated drawings. Therefore, it is to be understood that the disclosure is not to be limited to the specific embodiments disclosed and that modifications and other embodiments are intended to be included within the scope of this disclosure. Although specific terms are employed herein, they are used in a generic and descriptive sense only and not for purposes of limitation.

Unless defined otherwise, all technical and scientific terms used herein have the same meaning as commonly understood by one of skill in the art to which embodiments described herein pertain. Although any methods and materials similar to or equivalent to those described herein can be used in the practice or testing of embodiments of the present disclosure, the preferred methods and materials are described herein.

Existing control frameworks for direct-current (DC)/alternating-current (AC) power inverters are significantly customized and fine-tuned to a specific and fixed operating mode based on their intended use, limiting their versatility. For example, in the presence of a stiff grid, inverters operate in grid-following (GFL) mode, where they synchronize and supply power to the grid. On the other hand, in the absence of a viable or stiff grid, inverters usually operate in grid-forming (GFM) mode, where they not only control the power flow, but also provide voltage and frequency support at the point of common coupling (PCC). The other popular operating modes are the static synchronous compensator (STATCOM) and energy storage system (ESS), where the inverters serve as ancillary devices (grid support).

In STATCOM mode, the inverter improves voltage regulation and power transfer capacity by balancing reactive power. In contrast, an ESS acts as a rapidly dispatchable power source, primarily enhancing frequency control by exchanging active power with the connected AC system. The existing literature focuses predominantly on designing distinct control systems to address the objectives of each mode separately. However, with the increased integration of uncertain DERs and highly dynamic power consumption and generation profiles, it is becoming critical for the same inverter to operate in different operational modes at different times. In this context, the inverter control framework should facilitate a seamless transition between operating modes. For example, when most inverters operate in GFL mode with Maximum Power Point Tracking (MPPT), rapid spatio-temporal changes in irradiance (e.g., irradiance anomalies due to moving clouds) lead to rolling and non-localized power imbalance in the network. To address this issue, transitioning some of the inverters near the impacted MPPT areas to ESS or GFM can help locally adjust the power and prevent propagation of undesired voltage and frequency transients in the network.

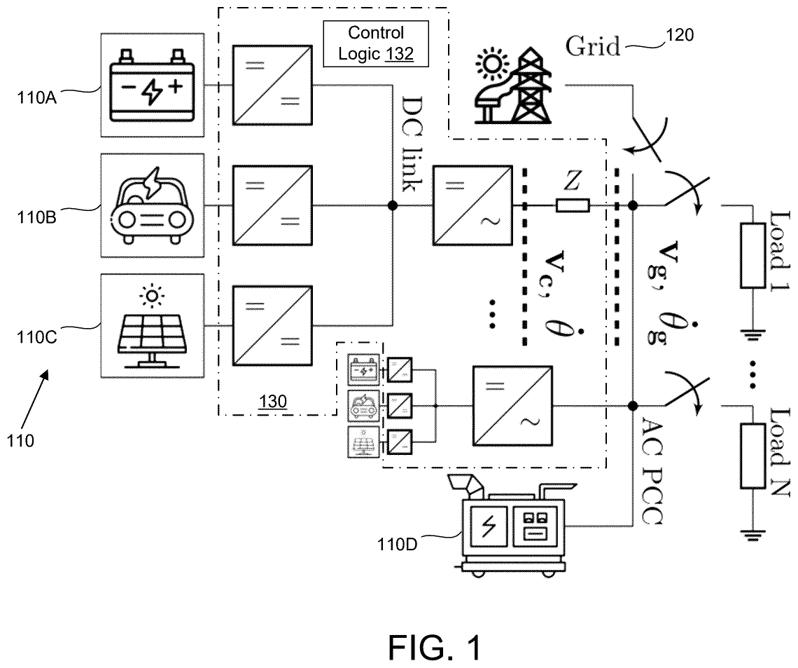

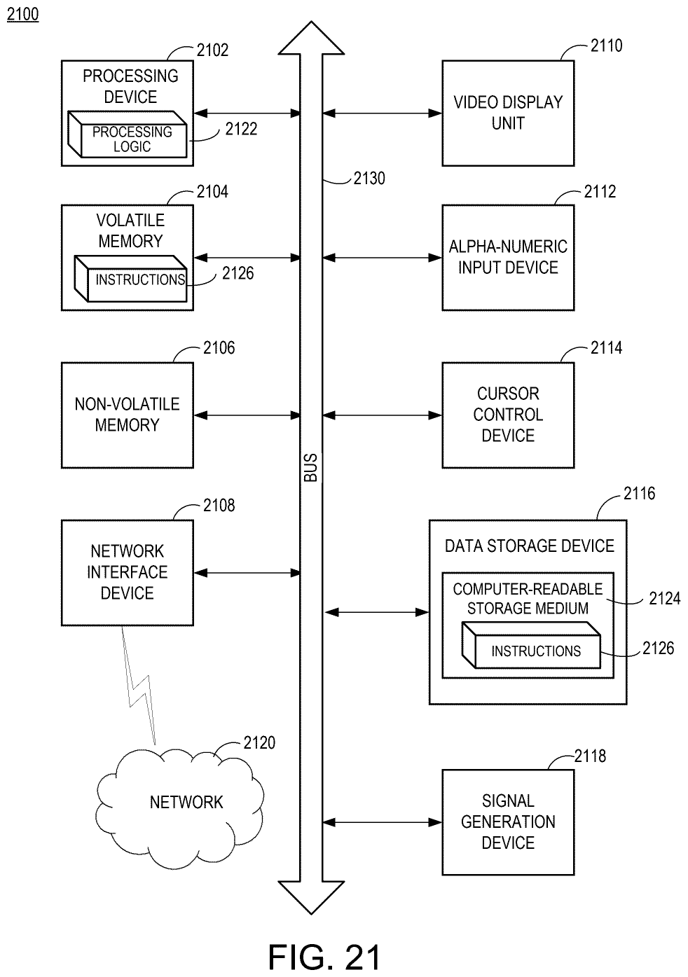

FIG. 1 is an operational schematic diagram illustrating a collection of inverter units to assimilate distributed energy resource and storage units 110 into a power grid 120 according to some embodiments. In embodiments, the energy resource and storage units 110 include batteries 110A, electric vehicles 110B, renewables 110C, and a generator set 110D that feed the power grid 120. The generator set 110D (also referred to as “gen set”) can provide a non-renewable source of power. Another common scenario involves transitioning between grid-tied (GFL) and islanded (GFM) modes, particularly during grid fault. This transition can be facilitated by reconfiguring and switching an inverter controller 130 based on islanding detection schemes, e.g., via control logic 132. In some embodiments, the inverter controller 130 is implemented by a computing device 2100 or computing system such as discussed with reference to FIG. 21. However, most islanding detection methods rely on real-time, centralized communication, making them vulnerable to communication delays and blackouts, which limits the robustness of the microgrid. Furthermore, sudden switching and reconfiguration of controllers can result in harmful transient response and instability in low-inertia inverter-based microgrids during the transition. Consequently, there has been increasing research on achieving seamless transition in weak-grid conditions without control reconfiguration and islanding detection.

Low-inertia refers to portions of a distributed and mix-source power grid lacking large synchronous generators (SG) that retain stored kinetic energy. This stored kinetic energy within such generators can act as a buffer to provide inertia when demand suddenly fluctuates. Microgrids made up of renewal power sources such as solar photovoltaic, wind turbines, batteries, and the like, are usually connected to the grid through power electronics, e.g., power inverters referred to here more generally as inverters. These renewal power sources, however, lack the natural inertia of large SG.

Synchronverters, which emulate the behavior of SG, offer a promising approach to seamless transition. These systems replace conventional voltage and current loops with angle, frequency, and torque controllers, providing emulated inertia and enhanced frequency dynamics. However, relying solely on SG dynamics may not fully exploit the fast dynamics of the inverters or allow for more advanced control strategies, potentially resulting in limited stability margins and suboptimal performance. Consequently, numerous studies have focused on improving stability margins, damping characteristics, and reducing sensitivity to weak grid coupling by leveraging inverter dynamics.

Another approach involves the perpetual operation of the inverters in droop-based grid-forming mode regardless of grid availability. These methods propose dynamically improved droop laws to maintain system stability in both grid-connected and islanded modes. Control strategies based on multivariate loop-shaping techniques are explored to decouple active and reactive power in weak grids. Although systematic, these approaches lack multiple-input multiple-output (MIMO) stability analysis, and performance analysis that generalizes beyond the proposed loop-shaping controller. At least one work provides a mode-dependent droop-based GFM that can operate in a grid-tied mode and improve reactive power regulation upon receiving a mode switch signal.

Aspects of the present disclosure address the above and other deficiencies of present multi-source power grid approaches through employing an integrated control system designed to achieve seamless transitions among a spectrum of inverter operational modes according to various embodiments. The operation spectrum can include, for example, grid-forming (GFM), grid-following (GFL), static synchronous compensator (STATCOM), energy storage system (ESS), and voltage source inverter (VSI). The proposed control architecture offers guarantees of stability, robustness, and performance regardless of the specific mode.

In some embodiments, the disclosed systems and methods establish a unified algebraic structure for the feedback control system, where different modes are defined by the magnitude of closed-loop signals. As demonstrated, this approach results in a two-dimensional continuum of operational modes and enables transition trajectories between operational modes by dynamically adjusting closed-loop variables towards corresponding setpoints. Stability, robustness, and fundamental limitation analyses are provided for the closed-loop system across any mode, as well as during transitions between modes. This design facilitates stable and enhanced on-grid integration, even during GFM operation and weak grid conditions. Ultimately, attributes of the proposed system are demonstrated through simulations and experiments designed to highlight its efficacy in managing on-grid operation and islanding scenarios, particularly in situations of weak grid operation. This disclosure provides extensive analysis by modeling the GFM in both on-grid and off-grid operations and investigating the root locus for a range of parameters.

In various embodiments, the disclosed control system solves the multi-mode operation challenge through three aspects that work together like layers of a control hierarchy. First, imagine a power inverter as a translator between DC and AC power that needs to speak different “languages” (e.g., control formulation) depending on needs of the power grid. In strong grid conditions, the power inverter acts like a current source (GFL mode), precisely following power commands. In weak or absent grid conditions, the power inverter acts like a voltage source (GFM mode), maintaining stable voltage and frequency. In some embodiments, therefore, the power inverter creates one unified translator that allows smooth translation between these languages. Second, the control system may simplify control by separating complex coupled dynamics (where voltage affects frequency and vice versa) into independent channels. Third, the system includes built-in safeguards against real-world uncertainties, e.g., variations in line impedance, measurement noise, and grid disturbances. These safeguards work like shock absorbers in a car, maintaining stable operation even when the “road” (grid conditions) becomes rough. The following disclosure details how these concepts are implemented mathematically and practically.

In some embodiments, a computing system is disclosed for functional integration with a distributed power grid having one or more inverters, e.g., inverters that control power flow between multiple power sources (such as DERs) in a multi-source ground. The computing system can include one or more processing devices and memory communicatively coupled with and readable by the one or more processing devices and having stored therein processor-readable instructions which, when executed by the one or more processing devices, cause the one or more processing devices to perform operations disclosed herein below. The operations, for example, can include controlling operation of an inverter, of the one or more inverters, by executing a feedback controller with a grid-tied line, of the distributed power grid, treated as a plant. The feedback controller can further include a unified algebraic control system operating based on a pair of closed-loop variables carried in closed-loop signals of the unified algebraic control system. The operations further include controlling, using the feedback controller, transitions of the inverter between a plurality of operating modes by adjusting a magnitude of the closed-loop signals, which correspond to the pair of closed-loop variables, towards a setpoint of a plurality of setpoints. In embodiments, each setpoint corresponds to a different operating mode of the plurality of operating modes.

The operations can further include quantifying sensitivities of a pair of two q-axis transfer functions of the unified algebraic control system. In embodiments, the pair of two q-axis transfer functions include: i) a closed-loop transfer function between a current setpoint and a grid current; and ii) a transient frequency response of the inverter. The operation can include generating a measure of robustness to model perturbations as a product of the sensitivities and bounding a frequency range of operation of the inverter according to bounds of the measure of robustness to preserve stability and performance characteristics under plant perturbations.

In related embodiments, a method for controlling distributed inverters in a multi-source power grid includes executing, by a computing system operatively coupled to the distributed inverters, a unified algebraic control system in which different operating modes of the distributed inverters are defined by magnitudes of closed-loop signals, wherein the different operating modes cause differing control of the distributed inverters, and the closed-loop signals are associated with a plurality of control parameters. The method can include parameterizing, within the unified algebraic control system, an operational space of the multi-source power grid as a two-dimensional continuum of the different operating modes using the plurality of control parameters. The method can include enabling smooth transitions between the operating modes by adjusting the plurality of control parameters along trajectories in the operational space between setpoints of the plurality of control parameters. The method can include maintaining, by the computing system, stability during inverter transitions through pointwise stability at each operating mode, of the operating modes, and a controlled rate of parameter change associated with the plurality of control parameters.

In some embodiments, the method further includes designing, within the unified algebraic control system, a d-axis controller and a q-axis controller with specified characteristics, These characteristics can include: the d-axis controller determines voltage regulation and reactive power support; the q-axis controller comprises parallel branches for frequency response and synchronization; and/or the plurality of control parameters are selected to achieve a target bandwidth, a target phase margin, and a target steady-state droop. The method can further include implementing a seamless transition between grid-connected and islanded operation without implementing control reconfiguration, islanding detection schemes, or communication-based coordination.

Therefore, advantages of the systems and methods implemented in accordance with some embodiments of the present disclosure include, but are not limited to, a unified control system that facilitates seamless transitions between different operating modes. Included in this approach is establishing a common algebraic system or framework for the feedback control system across various modes. In this structure, the operational space of the inverter can be viewed as a continuum of modes, including GFM, GFL, STATCOM, and ESS. Each mode can be parameterized by two control variables. Smooth transitions between modes can be enabled by adjusting these parameters along trajectories in the parameter space, starting and ending at setpoints corresponding to the initial and final modes. The proposed system transforms inverter control objectives into closed-loop properties of the feedback control structure. This approach inherently incorporates the benefits of existing state-of-the-art design concepts such as droop, virtual impedance, PLL, and inertia, without explicitly designing for them. In some embodiments, the present feedback control structure results in a universal characterization of stability, performance, and fundamental trade-offs for the MIMO closed-loop, regardless of the operational mode. Other advantages will be apparent to those skilled in the art of power semiconductor transistor design and fabrication, which will be discussed hereinafter.

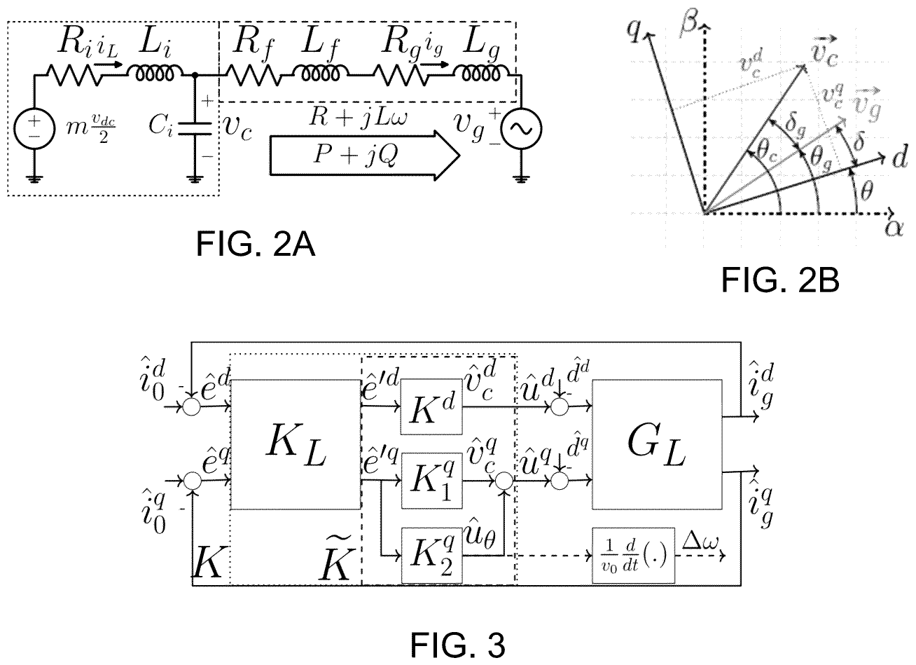

FIG. 2A is a circuit diagram illustrating an inverter as a controlled voltage source, v_{c}, connected to the power grid, v_{g}, via an resistor-inductor (RL) impedance according to various embodiments. FIG. 2B is a graph of dq synchronous rotating frame associated with FIG. 2A according to some embodiments. In the disclosed system, the inverter interface can be associated with a power network, which is common to all operational modes, as two voltage sources connected with an RL impedance as shown in FIG. 2A. Here, v_{c} is the inverter's capacitor voltage, while v_{g} represents the PCC voltage governed by the rest of the microgrid, i.e., the power grid and/or other inverter units. The RL impedance signifies the transmission line impedance R_{g}+jL_{g}ω and the grid side impedance of the LCL filter R_{f}+jL_{f}ω (R_{f}, L_{f}=0 in case of LC filter). Regardless of the mode of operation, it may be desired that the inverter in FIG. 2A maintains v_{c} close to the nominal value of v₀ while regulating the active and reactive power-flow {P, Q} through the impedance close to a {P₀, Q₀} set-point. The steady-state power-flow at fundamental frequency can be expressed as

$$P = ( \frac{\vert {v}_{c} \vert \vert {v}_{g} \vert}{Z} cos δ - \frac{\vert {v}_{g}^{2} \vert}{Z} ) cos {ϕ}_{z} - \frac{\vert {v}_{C} \vert \vert {v}_{G} \vert}{Z} sin {ϕ}_{z} sin δ , \qquad ( 1 )$$

$$Q = ( \frac{\vert {v}_{c} \vert \vert {v}_{g} \vert}{Z} cos δ - \frac{\vert {v}_{g}^{2} \vert}{Z} ) sin {ϕ}_{z} + \frac{\vert {v}_{C} \vert \vert {v}_{G} \vert}{Z} cos {ϕ}_{z} sin δ ,$$

where δ is the phase difference between v_{c} and v_{g} and Z∠φ_{z}:=R+jLω in FIG. 2A. Different operating modes balance trade-offs between deviations in inverter output power and voltage from their nominal setpoints. For example, GFM and GFL inverters differ in the allowable voltage magnitude and frequency deviations to accommodate accurate tracking of the power reference, as set forth in Equation (1).

In some embodiments, the fundamental trade-offs between control objectives are characterized not only at steady-state, but throughout the frequency spectrum. Therefore, instead of relying on the nonlinear steady-state power flow equation in Equation (1) or the dynamic power phasor, exploited are the rich and linear dynamics of the grid current, i_{g}, for the design and analysis of closed-loop control. In this context, the averaged dynamical model of the transmission line and inverter, as illustrated in FIG. 2A, in the direct quadrature (dq) frame can be expressed as

$$L \frac{d \vec{{ι}_{g}}}{dt} = \vec{{v}_{c}} - \vec{{v}_{g}} - R \vec{{ι}_{g}} - L ( {{ω}_{0} [ - {i}_{g}^{q} , {i}_{g}^{d} ]}^{T} + ψ ( t , \vec{{ι}_{g}} ) ) \qquad ( 2 )$$

$${L}_{i} \frac{d \vec{{ι}_{L}}}{dt} = \frac{{v}_{dc}}{2} \vec{m} - \vec{{v}_{c}} - {R}_{i} \vec{{ι}_{L}} - {L}_{i} {\dot{θ} [ - {i}_{L}^{q} , {i}_{L}^{d} ]}^{T} , \qquad ( 3 )$$

$${C}_{i} \frac{d \vec{{v}_{c}}}{dt} = \vec{{ι}_{L}} - \vec{{ι}_{G}} - {C}_{i} {\dot{θ} [ - {v}_{c}^{q} , {v}_{c}^{d} ]}^{T} .$$

Here θ is the angular frequency of the dq frame, ω₀ is the nominal frequency,

$$ψ ( t , {\to }_{{i}_{g}} ) = {( θ - {ω}_{0} ) [ - {i}_{L}^{q} , {i}_{g}^{d} ]}^{T}$$

is sector-bounded nonlinearity,

$$( {v}_{dc} / 2 ) {\to }_{m}$$

is the cycle-averaged model of the switching node, and each vector contains the respective d and q signal components. Applying the Laplace transform to Equation (2) and Equation (3) results in

$$\vec{{\hat{ι}}_{g}} = {G}_{L} ( {\vec{\hat{v}}}_{c} - {\vec{\hat{v}}}_{g} ) , where {G}_{L} = \frac{[ \begin{matrix}s + λ & {ω}_{0} \\ - {ω}_{0} & s + λ\end{matrix} ]}{L ( {s}^{2} + 2 λ s + {λ}^{2} + {ω}_{0}^{2} )} and λ = \frac{R}{L} , \qquad ( 4 )$$

$${\vec{\hat{v}}}_{c} = \frac{1}{{C}_{i} s} ( {\vec{\hat{ι}}}_{L} - {\vec{\hat{ι}}}_{g} - ℒ \{ {C}_{i} {θ [ - {v}_{c}^{q} , {v}_{c}^{d} ]}^{T} \} ) , \qquad ( 5 )$$

$${\vec{\hat{ι}}}_{L} = \frac{1}{{L}_{i} s + {R}_{i}} ( \frac{{v}_{dc}}{2} \vec{\hat{m}} - {\vec{\hat{v}}}_{c} - ℒ \{ {L}_{i} {θ [ - {i}_{L}^{q} , {i}_{L}^{d} ]}^{T} \} )$$

where the hat notation signifies the Laplace domain signals, s is the Laplace variable, and [symbol] {⋅} is Laplace transform.

In some embodiments, the effect of nonlinearity ψ(⋅, ⋅) is neglected in Equation (4). However, in Proposition 9.1 associated with Equation (75), sufficient conditions are established for the nominal closed-loop system under which the nonlinearity is sector-bounded and does not compromise closed-loop stability. Therefore, it is justifiable to neglect nonlinearity ψ when the conditions outlined in Proposition 9.1 are met. Unlike the frequency-invariant input-output coupling in Equation (1), the frequency-dependent input-output coupling in Equation (4) allows design of controllers that achieve improved stability margins by exploiting the dynamic nature of the MIMO coupling.

FIG. 3 is a circuit diagram illustrating a proposed closed-loop with line dynamics G_{L} in Equation (4) as plant and K=\tilde{K}K_{L} as a multiple input, multiple output (MIMO) feedback controller according to some embodiments. In embodiments, the K_{L} is the full matrix part of K, while

$$\tilde{K} = diag ( {K}^{d} , {K}_{1}^{q} + {K}_{2}^{q} )$$

is the diagonal part of the controller. The input disturbances {d^{d}, d^{q}} capture the effect of the PCC on the closed-loop, while {u^{d}, u^{q}} integrates the capacitor voltage and the dq frame angle θ as closed-loop control effort.

In some embodiments, the closed-loop block diagram in FIG. 3 can be employed to analyze the stability and performance of the inverter and grid setup in FIG. 2A. In this context, G_{L} represents the MIMO line dynamics in Equation (4) and the feedback controller K encapsulates the inverter dynamics in Equation (5). However, before the performance and stability are evaluated in terms of closed-loop in FIG. 3, one can resolve the control input \vec{u}=[u^{d}, u^{q}]^{τ} and disturbance \vec{d}=[d^{d}, d^{q}]^{τ} in terms of the inverter and grid state variables.

Proposition 3.1: For the closed-loop structure in FIG. 3, the control input \vec{u} and disturbance \vec{d} are

$$[ \begin{matrix}{u}^{d} \\ {u}^{q}\end{matrix} ] = [ \begin{matrix}Δ {v}_{c}^{d} \\ Δ {v}_{c}^{q}\end{matrix} ] + [ \begin{matrix}0 \\ {u}_{θ}\end{matrix} ] , and [ \begin{matrix}{d}^{d} \\ {d}^{q}\end{matrix} ] = [ \begin{matrix}Δ {v}_{g} \\ ‖ {v}_{g} ‖ \int Δω dt\end{matrix} ] , \qquad ( 6 )$$

where

$$Δ {v}_{c}^{d} = {v}_{c}^{d} - {v}_{0} , Δ {v}_{g} = ‖ {v}_{g} ‖ - {v}_{0} , Δ {v}_{c}^{q} = {v}_{c}^{q} - 0 , {u}_{θ} ( t ) = ‖ {v}_{g} ‖ \int Δω dt , Δ ω = θ - {ω}_{θ} ,$$

and Δω_{g}=ω_{g}−ω₀. The control input u may represent what the inverter can actively control: the capacitor voltage deviation and the rotating reference frame angle. The disturbance d may represent what the inverter cannot control but responds to: grid voltage variations and grid frequency changes. These are the fundamental signals that determine whether the inverter maintains stable operation.

Proof 3.1: Base on FIG. 3 and Equation (4) result \vec{v}−\vec{d}=\vec{v}_{c}−\vec{v}_{g}=(\vec{v}_{c}−[\vec{v}ₒ, 0]^{τ})−(\vec{v}_{g}−[v₀, 0]^{τ})−(\vec{v}_{g}−[v₀, 0]^{τ}). Therefore, the difference between \vec{u} and \vec{d} can be expressed as

$$\vec{u} - \vec{d} = [ \begin{matrix}Δ {v}_{c}^{d} \\ Δ {v}_{c}^{q}\end{matrix} ] [ \begin{matrix}‖ {v}_{g} ‖ cos ( δ ) - {v}_{0} \\ ‖ {v}_{g} ‖ sin ( δ )\end{matrix} ] \approx [ \begin{matrix}Δ {v}_{c}^{d} \\ Δ {v}_{c}^{q}\end{matrix} ] - [ \begin{matrix}Δ {v}_{g} \\ ‖ {v}_{g} ‖ δ\end{matrix} ] . \qquad ( 6 a )$$

In Equation (6a), δ=θ_{g}−θ is the angle between v_{g} and the dq rotating frame. Furthermore, ∥v_{g}∥δ=d^{q}−u_{θ} where

$${d}^{q} = ‖ {v}_{g} ‖ {\int }_{{t}_{0}}^{t} ( {\dot{θ}}_{g} ( τ ) - {ω}_{0} ) d τ , {u}_{θ} = ‖ {v}_{g} ‖ {\int }_{{t}_{0}}^{t} ( {\dot{θ}}_{g} ( τ ) - {ω}_{0} ) d τ . \qquad ( 6 b )$$

Here, the capacitor voltage, Δ\vec{v}_{c}, and dq rotating angle, θ, are controllable, while the grid states, Δv_{g} and θ_{g}, are not measurable or even controllable. Therefore, Equation (6) can be recovered.

Some embodiments include a non-transitory computer-readable storage medium storing instructions that, when executed by one or more processors, cause the one or more processors to perform operations for inverter control. In embodiments, the operations include executing a feedback control algorithm that treats power grid connection of one or more inverters, of a multi-source power grid, as a plant comprising resistor-inductor impedance. The operations can further include maintaining, associated with the feedback control algorithm, a two-dimensional operating space parameterized by voltage and frequency control variables associated with the multi-source power grid. In embodiments, the operations include causing, using the feedback control algorithm, transitions between a plurality of operating modes of the one or more inverters by adjusting the voltage and frequency control variables according to grid conditions and power requirements of the multi-source power grid. In embodiments, the operations include ensuring stability of operation of the one or more inverters within the multi-source power grid through satisfaction of sector-boundedness conditions for nonlinear dynamics modeled within the feedback control algorithm.

Grid disturbance d is unknown; however, the following disturbance model can be adapted for closed-loop analysis, as follows:

$$[ \begin{matrix}{\hat{d}}^{d} \\ {\hat{d}}^{q}\end{matrix} ] = [ \begin{matrix}1 & 0 \\ 0 & {v}_{0} / s\end{matrix} ] [ \begin{matrix}Δ {v}_{g} / s \\ Δ {ω}_{g} / s\end{matrix} ] + \vec{\hat{η}} ( s ) . \qquad ( 7 )$$

The above disturbance model assumes nominally constant deviations in voltage and frequency if the power grid, with \vec{η}(s) representing unmodeled disturbances. The model can be updated in Equation (7) if additional information on grid dynamics is available. For example, in the case of a line-to-ground fault, one can include the second-order harmonic model in Equation (7).

In some embodiments, the closed-loop in FIG. 3 maps the current set-point \vec{ι}₀, and grid disturbance \vec{d}, as defined in Equation (7), into the grid current \vec{ι}_{g} and control signal \vec{u} as

$$\vec{{\hat{ι}}_{g}} = {G}_{L} S ( K \vec{{\hat{ι}}_{0}} - \vec{\hat{d}} ) , \vec{\hat{u}} = T ( {G}_{L}^{- 1} \vec{{\hat{ι}}_{0}} + \vec{\hat{d}} ) , where \qquad ( 8 )$$

In Equations (8), S and T represent the sensitivity transfer function and complementary sensitivity transfer function, respectively. associated with the closed-loop system in FIG. 3. Moreover, the S and T transfer functions in Equation (8) are defined in terms of closed-loop plant G_{L} and feedback controller K shown in FIG. 3 as

$$S = {( {I}_{2} + K {G}_{L} )}^{- 1} , T = {I}_{2} - S = K {{G}_{L} ( {I}_{2} + K {G}_{L} )}^{- 1} . \qquad ( 9 )$$

It can be clear from Equation (8) that the closed-loop objectives and internal stability may hinge on the sensitivity S and complementary sensitivity T transfer functions in Equation (9). Furthermore, both S and T are shaped by designing a feedback compensator K. In some embodiments, the MIMO feedback compensator K represents a two-by-two matrix of transfer functions with a specific structure.

In the context of Equation (8) and FIG. 3, the primary challenge in closed-loop analysis and control synthesis arises from the coupled MIMO dynamics of the plant G_{L} as defined in Equation (4) and feedback controller K. In embodiments, these two MIMO transfer matrices, G_{L}, and K, form the MIMO sensitivity S per definition in Equation (9). Moreover, the sensitivity S is the primary transfer function that defines the input-output behavior of the closed-loop per Equation (8). In this disclosure, the coupling problem of the MIMO sensitivity S can be mitigated by factoring closed-loop sensitivity S in Equation (9) into diagonal (2-SISO, or single input, single output) sensitivity \tilde{S} defined in Equation (10) and a multiplicative coupled perturbation ΓX_{c} where Γ and X_{c} are MIMO transfer matrices defined in Equation (10). In this regard, the MIMO sensitivity S=ΓX_{c}\tilde{S}. Subsequently, the bounds for the perturbation ∥ΓX_{c}∥ can be derived, thus converting the MIMO analysis and synthesis problems into a simpler SISO problem based on the nominal 2-SISO sensitivity \tilde{S}, which factorization enables simplifying control. In practical terms, this proposed factorization is like breaking a complex recipe into simpler sub-recipes. The MIMO sensitivity S (which determines how disturbances affect the system output) can be split into: a diagonal part \tilde{S} (controlling each axis independently) and a coupling term ΓX_{c} (representing the interaction between axes). By making the coupling term small, one can design controllers for each axis separately, dramatically simplifying the control problem.

The disclosed system and method can obtain this factorization by decomposing the controller K into a product of two controller components, \tilde{K}K_{L}, where \tilde{K}=diag(K^{d}, K^{q}) is a diagonal controller component, and K_{L} is a stable, proper two-by-two MIMO transfer matrix. The diagonal controller component can be configured to maintain stability and achieve target objectives associated with a decoupled d-axis and a decoupled q-axis under an impact of the modified plant. Also, in the context of FIG. 3, the modified plant can be defined as G_{M}=K_{L}G_{L} and factorized as G_{M}=\tilde{G}_{M}(I₂+E), where

$${\tilde{G}}_{M} = diag ( {G}_{M}^{d} , {G}_{M}^{q} )$$

includes the diagonal elements of G_{M}, and

$$E = {G}_{M}^{- 1} ( {G}_{M} - {\tilde{G}}_{M} )$$

represents the coupling terms. The factorization of the MIMO sensitivity transfer function can be summarize as S as follows.

Proposition 3.2: (a) Factorization of Sensitivity. The MIMO sensitivity S in (9) can be factored into a nominal 2-SISO sensitivity \tilde{S}=diag(\tilde{S}^{d}, \tilde{S}^{q}) and coupled perturbation ΓX_{c} as

$$S = {Γ𝒳}_{c} \tilde{S} , where Γ = {G}_{M}^{- 1} {\tilde{G}}_{M} , {𝒳}_{c} = {( {I}_{2} + \tilde{S} ( Γ - {I}_{2} ) )}^{- 1} , and \qquad ( 10 )$$

$$\tilde{S} = {( {I}_{2} + \overline{K} {\tilde{G}}_{M} )}^{- 1} = [ \begin{matrix}{( 1 + {K}^{d} {G}_{M}^{d} )}^{- 1} & 0 \\ 0 & {( 1 + {K}^{q} {G}_{M}^{q} )}^{- 1}\end{matrix} ] .$$

(b) Coupling Strength. The coupling impact of X_{c} in Equation (10) between the input and output of the system can be bounded as follows

$${‖ {𝒳}_{c} ( j ω ) - {I}_{2} ‖}_{2} \leq \frac{ϵ ( ω )}{1 - ϵ ( ω )} \qquad ( 11 )$$

Here ϵ(ω) represents the size of coupling dynamics and captures how small and insignificant the impact is of coupling on system dynamics. In mathematical term ϵ(ω) can be defined as ϵ(ω)=∥S(jω)∥₂∥Γ(jω)−I₂∥₂ and it may be desired to keep ϵ(ω) small to avoid complications arising from coupled dynamics in the system. The definition of ϵ(ω) allows us to effectively design the sensitivity S or Γ to reduce the coupling dynamics as explained below after Equation (14). In embodiments, the robustness is quantified by a coupling strength metric based on deviation from diagonal plant structure sensitivity bounds at fundamental and harmonic frequencies. The robustness can further be quantified by a condition number of modified plant across operating frequency range.

(c) Closed-Loop Characterization: Effect of the coupling X_{c} and 2-SISO sensitivity components \tilde{S} on closed-loop dynamics in Equation (8) can be expressed as

$$\vec{{\hat{ι}}_{g}^{′}} = {\tilde{G}}_{M} {𝒳}_{c} \tilde{S} ( \tilde{K} \vec{{\hat{ι}}_{0}} - \vec{\hat{d}} ) , \vec{\tilde{u}} = \tilde{K} {\tilde{G}}_{M} {𝒳}_{c} \tilde{S} ( {G}_{M}^{- 1} \vec{{\hat{ι}}_{0}} + \vec{\hat{d}} ) . \qquad ( 12 )$$

Proof 3.2: (a) Using K=\tilde{K}K_{L} and G_{M}=K_{L}G_{L} can result in sensitivity expressed as

$$S = {( {I}_{2} + K {G}_{L} )}^{- 1} = {( {I}_{2} + \tilde{K} {K}_{L} {G}_{L} )}^{- 1} = {( {I}_{2} + \tilde{K} {G}_{M} )}^{- 1} . \qquad ( 13 )$$

Replacing the modified plant G_{M} by \tilde{G}_{M}(I₂+E) can result in

$${( {I}_{2} + \tilde{K} {\tilde{G}}_{M} ( {I}_{2} + E ) )}^{- 1} = {( {I}_{2} + \tilde{S} \tilde{K} {\tilde{G}}_{M} E )}^{- 1} {( {I}_{2} + \tilde{K} {\tilde{G}}_{M} )}^{- 1}$$

The identity \tilde{S}\tilde{K}\tilde{G}_{M}=I₂−\tilde{S} in above can be used to obtain

$$S = {( {I}_{2} + ( {I}_{2} - \tilde{S} ) E )}^{- 1} {( {I}_{2} + \tilde{K} {\tilde{G}}_{M} )}^{- 1} . \qquad ( 14 )$$

As final step, E can be replaced by (Γ⁻¹−I₂) and factor out Γ⁻¹ to arrive at the factorization in Equation (10). The Neumann series can be employed to achieve

$${𝒳}_{c} - {I}_{2} = {( {I}_{2} + \tilde{S} ( Γ - {I}_{2} ) )}^{- 1} - {I}_{2} = {\sum }_{n = 1}^{∞} {( - \tilde{S} ( Γ - {I}_{2} ) )}^{n}$$

where the right-hand side of the above is bounded by geometric series below

$${\sum }_{n = 1}^{∞} {( ‖ Γ ( j ω ) - {I}_{2} ‖ {‖ \tilde{S} ( j ω ) ‖}_{2} )}^{n} = \frac{ϵ ( ω )}{1 - ϵ ( ω )}$$

(c) The proof follows from replacing the sensitivity factorization of Equation (10) into Equation (8) and Equation (9). In some embodiments, the operations include factoring multiple input, multiple output (MIMO) sensitivity into diagonal two-single input, single output (2-SISO) sensitivity components and multiplicative coupled perturbation terms. In embodiments, the factorization enables conversion of MIMO analysis into simpler SISO problems than the MIMO analysis. In related embodiments, controlling the transitions between operating modes includes modeling, using direct quadrature formulation, inputs and outputs of the unified algebraic control system using a pair of a single input, single output (SISO) models including sensitivity and a multiplicative perturbation and deriving a coupling between the pair of SISO models. In embodiments, the operations further include factoring a set of primary closed-loop models and a corresponding closed-loop sensitivity model into a set of diagonal parts. The operations can include determining a bounded coupling perturbation between the set of diagonal parts and shaping sensitivity of the set of diagonal parts to minimize the bounded coupling perturbation.

Based on Equation (11), we can decrease e by (a) reducing the sensitivity \tilde{S}, as defined in Equation (10), through a control design for \tilde{K}, that represents the diagonal part of feedback controller K, or (b) shaping the coupling term Γ, defined in Equation (10), close to identity. In this work, we assume that the design satisfies ∥ϵ∥_{∞}≤0.1 and that the approximation [symbol] ≈I₂ is accurate for transient and steady-state analysis. Therefore, the input-output relation in Equation (12) simplifies into

$$\vec{{\hat{ι}}_{g}^{′}} = \tilde{T} \vec{{\hat{ι}}_{0}^{′}} - {\tilde{G}}_{M} \tilde{S} \vec{\hat{d}} , \vec{\hat{u}} = \tilde{T} ( {G}_{M}^{- 1} \vec{{\hat{ι}}_{0}^{′}} + \vec{\hat{d}} ) , \vec{{\hat{e}}^{′}} = \tilde{S} ( \vec{{ι}_{0}^{′}} + {\tilde{G}}_{M} \vec{\hat{d}} ) \qquad ( 15 )$$

where

$$\vec{{ι}_{g}^{′}} = {K}_{L} \vec{{ι}_{g}} , \vec{{ι}_{0}^{′}} = {K}_{L} \vec{{ι}_{0}} , {\vec{e}}^{′} = {K}_{L} \vec{e}$$

and \tilde{T} is a 2-SISO complementary sensitivity defined below

$$\tilde{T} = {I}_{2} - \tilde{S} = \tilde{S} \tilde{K} {\tilde{G}}_{M} = [ \begin{matrix}{\tilde{S}}^{d} {K}^{d} {G}_{M}^{d} & 0 \\ 0 & {\tilde{S}}^{q} {K}^{q} {G}_{M}^{q}\end{matrix} ] . \qquad ( 16 )$$

The primary transfer matrices in Equation (15) are diagonal as denoted by the tilde (˜) notation. This allows circumvention of the difficulties of MIMO control and develop a simplified but comprehensive system for closed-loop control design and analysis. In practical terms, this factorization technique simplifies the complex multi-input, multi-output (MIMO) control problem into two simpler single-input, single-output (2-SISO) problems. This is analogous to solving two simple equations instead of one complex coupled equation for closed-loop control. The sensitivity transfer matrix S represents how much the system's output deviates from the desired setpoint when disturbances occur. By breaking S into diagonal components (\tilde{S}) and coupling terms (Γχ_{c}), we can design controllers independently for voltage (d-axis) and frequency (q-axis) control, then account for their interaction separately.

In some embodiments, the characterization of MIMO stability in terms of SISO and coupling perturbation stability can be exploited. The SISO factorization of S can be exploited in Proposition 3.2 to propose novel stability criteria for control synthesis.

Proposition 4.1: In practical terms, stability means the inverter does not oscillate or diverge when subjected to (grid) disturbances, like ensuring a bridge won't collapse under wind loads. The internal stability of the closed-loop controller in FIG. 3 is guaranteed if (a) holds with either (b) or (c), listed as follows.

(a) SISO Condition: \tilde{S}^{d}, and \tilde{S}^{q} in (10) are stable. This means each axis (voltage and frequency) is individually stable when considered in isolation.

(b) Decoupling Condition: G_{M} is triangular or diagonal. Physically, this means the controller K_{L} has successfully eliminated cross-coupling between voltage and frequency control.

(c) Magnitude Condition: ϵ in (11) satisfies ∥ϵ(ω)∥_{∞}<1. This bounds the residual coupling effects to ensure they do not destabilize the system.

Proof 4.1: The plant G_{L} and the controller K are stable and minimum phase (we consider stable and minimum phase controllers); hence, the closed-loop in FIG. 3 is internally stable when S is stable. The stability of \tilde{S} and χ_{c} is sufficient for the stability of S (Γ is stable if K_{L} is minimum phase). Condition (a) assumes that \tilde{S} is stable; the stability of the coupling term [symbol] _{c} is guaranteed through the spectral radius condition ρ(\tilde{S}(jω)(Γ(jω)−I₂))<1, ∀ω. The ϵ as defined in Equation (11) is an upper bound on the spectral radius; therefore, the magnitude condition in (c) provides a sufficient but conservative guarantee for the stability of [symbol] _{c}. The condition in (b) is less conservative than (c) and can directly guarantee that the spectral radius is zero irrespective of the magnitude and shape of \tilde{S}. If G_{M} is triangular, then

$$Γ - {I}_{2} = {G}_{M}^{- 1} {\tilde{G}}_{M} - {I}_{2}$$

can be strictly triangular and, consequently, \tilde{S}(Γ−I₂) can also be strictly triangular. All the eigenvalues of a strictly triangular matrix are zero; hence, irrespective of \tilde{S}, a spectral radius can be equal to zero.

From this theorem, one can guarantee stability of [symbol] _{c} by either reducing the magnitude of \tilde{S} or shaping the modified plant G_{M} into a triangular or diagonal matrix. Maintaining two distinct methods can be helpful, since reducing \tilde{S} requires a high-gain controller \tilde{K} (see Equation (10)), which is not always feasible. For instance, in GFM operation, as we shall see later, the low-frequency gain of the controller is bounded above, limiting the feasible reduction in sensitivity at low frequencies. Moreover, in any case, \tilde{S} converges to the identity at high frequencies for a proper feedback controller.

In some embodiments, the algebraic structure of plant shaping controller can be employed as follows. In scenarios where it is not possible to arbitrarily reduce \tilde{S} (e.g., GFM operation), Proposition 4.1(b) imposes a structure K_{L} such that the modified plant G_{M}=K_{L}G_{L} is triangular or diagonal. To characterize such a structure, one can consider a static row normalized K_{L} as

$${K}_{L} = [ \begin{matrix}cos {ϕ}_{1} & - sin {ϕ}_{1} \\ sin {ϕ}_{2} & cos {ϕ}_{2}\end{matrix} ] \qquad ( 17 )$$

where φ₁, φ₂∈[0, π/2]. In the following proposition, the parameters φ₁ and φ₂ can be associated with the stability margin of the coupling term [symbol] _{c} and the conditioned number of the modified plant G_{M}=K_{L}G_{L}. Subsequently, a transfer function K_{L}(s) that simultaneously achieves optimal stability margins can be obtained at both low and high frequencies.

Proposition 4.2: (a) The modified plant G_{M}(j0) satisfies Proposition 4.1(b) in steady state if φ₁=φ_{z} or φ₂=φ_{z}. Here, φ_{z}=arctan X/R where X=Lω₀ and R are the transmission line reactance and resistance.

(b) At high frequency (s→∞) the stability margin of coupling term χ_{c} for K_{L} in (17) converges to

$${lim}_{s \to ∞} det ( {𝒳}_{c} ) = \frac{cos ( {ϕ}_{1} - {ϕ}_{2} )}{cos {ϕ}_{1} cos {ϕ}_{2}} . \qquad ( 18 )$$

For φ₁=0 or φ₂=0, the stability margin is 1 (optimal) irrespective of the line impedance phase angle φ_{z}. Hence, a static [symbol] _{c} can achieve an optimal stability margin at low and high frequencies if {φ₁=φz, φ₂=0} or {φ₁=0, φ₂=φ_{z}}.

(c) The condition number of the modified plant G_{M}=K_{L}G_{L} at both low and high frequencies is given as

$${lim}_{ω \to ∞} κ ( {G}_{M} ( j ω ) ) = κ ( {G}_{M} ( j 0 ) ) = \sqrt{\frac{1 + ‖ sin ( Δϕ ) ‖}{1 - ‖ sin ( Δϕ ) ‖}} \qquad ( 19 )$$

where Δφ=φ₁−φ₂. A small condition number indicates the robustness of the plant to input uncertainty. A large condition number, however, implies lack of effective control over plant output associated with smallest singular value. We achieve the smallest possible condition number of one for φ₁=φ₂. Static K_{L} cannot satisfy (a) and (b) and achieve the optimal condition number simultaneously, except for resistive lines.

Proof 4.2: (a) define Z=\sqrt{X²+R²} and φ₁=φ_{z} then

$${G}_{M} ( j 0 ) = {K}_{L} ( j 0 ) {G}_{L} ( j 0 ) = \frac{1}{Z} [ \begin{matrix}1 & 0 \\ sin ( {ϕ}_{2} - {ϕ}_{z} ) & 1\end{matrix} ] \qquad ( 20 )$$

The case for φ₂=φ_{z} follows the same but instead results in an upper triangular matrix.

(b) The

$${lim}_{s \to ∞} \tilde{S} = {I}_{2}$$

can result, therefore

$${lim}_{s \to ∞} det ( {𝒳}_{c} ) = {lim}_{s \to ∞} {det ( Γ )}^{- 1} .$$

Moreover, det(Γ)⁻¹=det(K_{L})det(G_{L})/det(\tilde{G}m). Taking into account that det(K_{L})=cos(φ₁−φ₂), one can obtain

$${lim}_{s \to ∞} {det ( Γ )}^{- 1} = cos ( {ϕ}_{1} - {ϕ}_{2} ) {lim}_{s \to ∞} \frac{det ( {G}_{L} )}{det ( {\tilde{G}}_{M} )} = \frac{cos ( {ϕ}_{1} - {ϕ}_{2} )}{cos ( {ϕ}_{1} ) cos ( {ϕ}_{2} )} \qquad ( 20 a )$$

and the proof is complete.

(c) For an arbitrary φ₁, φ₂∈[0, π/2] can result in

$${G}_{M} ( j 0 ) = \frac{1}{Z} [ \begin{matrix}cos ( {ϕ}_{1} - {ϕ}_{z} ) & - sin ( {ϕ}_{1} - {ϕ}_{z} ) \\ sin ( {ϕ}_{2} - {ϕ}_{z} ) & cos ( {ϕ}_{2} - {ϕ}_{z} )\end{matrix} ] \qquad ( 21 )$$

and therefore

$$\overline{σ} ( {G}_{M} ( j 0 ) ) = \sqrt{1 + ‖ sin ( {ϕ}_{1} - {ϕ}_{2} ) ‖} , \underline{σ} ( {G}_{M} ( j 0 ) ) = \sqrt{1 - ‖ sin ( {ϕ}_{1} - {ϕ}_{2} ) ‖} . \qquad ( 21 a )$$

The Proposition 4.2 outlines a design for a static K_{L}. One can use the same analysis to obtain the transfer matrix K_{L}(s). One particular choice that satisfies the stability conditions in (a), (b), and the optimal condition number in Equation (19) is

$${K}_{L} ( s ) = \frac{{ω}_{m}}{s + {ω}_{m}} [ \begin{matrix}\frac{L}{Z} s + cos {ϕ}_{z} & - sin {ϕ}_{z} \\ sin {ϕ}_{z} & \frac{L}{Z} s + cos {ϕ}_{z}\end{matrix} ] . \qquad ( 22 )$$

This K_{L} result in the diagonal modified plant can be inserted into G_{M} as

$${G}_{M} = {K}_{L} {G}_{L} = \frac{{ω}_{m} / Z}{s + {ω}_{m}} {I}_{2} = {\tilde{G}}_{M} . \qquad ( 23 )$$

Many choices for the transfer matrix K_{L}(s) satisfy the stability conditions in Proposition 4.2(a) and Proposition 4.2(b). The proposed K_{L} in Equation (22) is one such a choice that also achieves an optimal condition number. As discussed in more detail later, one can adopt a K_{L}(s) with a suboptimal condition number that offers more attractive power sharing performance. The plant shaping controller K_{L} acts like a pre-filter that transforms the inherently coupled dynamics of the power line into a form that is easier to control. When properly designed, K_{L} makes the d-axis (voltage/reactive power) and q-axis (frequency/active power) behave independently at critical frequencies, eliminating problematic interactions that could cause instability.

In some embodiments, the feedback controller includes a multiple input, multiple output (MIMO) feedback controller decomposed into a MIMO plant shaping controller component configured to transform line dynamics into a modified plant with reduced coupling and cross-channel interaction between a d-axis for voltage and a q-axis for frequency. The feedback controller can also include a diagonal controller component configured to maintain stability and achieve target objectives associated with a decoupled d-axis and a decoupled q-axis under an impact of the modified plant. The operations may further include implementing a plant shaping controller that satisfies decoupling conditions at steady state through triangular or diagonal structure, stability margin optimization at high frequencies, and/or condition number optimization for robustness to input uncertainty. In some embodiments, the plant shaping controller component is configured to achieve: diagonal modified plant dynamics at steady state; triangular modified plant dynamics at steady state; and/or an optimal condition number for the modified plant across frequency ranges for a highest stability margin.

In some embodiments, specifying objectives and operating modes based on the closed-loop sensitivity can be employed. In seeking for sensitivity and inverter closed-loop objectives, relevant steady-state control objectives for inverters include

$${lim}_{t \to ∞} Δ \vec{{v}_{c}} ( t ) = 0 , {lim}_{t \to ∞} Δω ( t ) = 0 , {lim}_{t \to ∞} {\vec{e}}^{′} ( t ) = 0$$

In the context of FIG. 3 and Equation (6), Δ\vec{v}_{c} and Δω are inverter capacitor voltage deviation from the nominal value, and inverter frequency deviation from nominal value. These are also components of the closed-loop control effort \vec{u}, while \vec{e}′ represents the modified current feedback error. This observation, together with Equation (15), facilitates formulating inverter control objectives in terms of closed-loop sensitivity \tilde{S} and complementary sensitivity \tilde{T} as follow

$${‖ \vec{u} ‖}_{2} \leq {‖ \tilde{T} ‖}_{2} {‖ {G}_{M}^{- 1} \vec{{\hat{ι}}_{0}} + \vec{\hat{d}} ‖}_{2} , {‖ \vec{{\hat{e}}^{′}} ‖}_{2} \leq {‖ \tilde{S} ‖}_{2} {‖ \vec{{\hat{ι}}_{0}^{′}} + {\tilde{G}}_{M} \vec{\hat{d}} ‖}_{2} \qquad ( 24 )$$

In some embodiments, it is desirable to minimize ∥\tilde{T}∥₂ and ∥\tilde{S}∥₂ to reduce effect of the exogenous inputs {\vec{ι}₀, \vec{d}} on {\vec{u}, \vec{e}}, thereby improving voltage, frequency, and current regulation. However, the algebraic constraint \tilde{S}+\tilde{T}=I₂, evident from Equation (16), indicates a fundamental trade-off. This trade-off exists between achieving perfect voltage and frequency regulation (VSI operation) by keeping ∥\tilde{S}∥₂ small and perfect current tracking (GFL operation) by reducing ∥\tilde{T}∥₂.

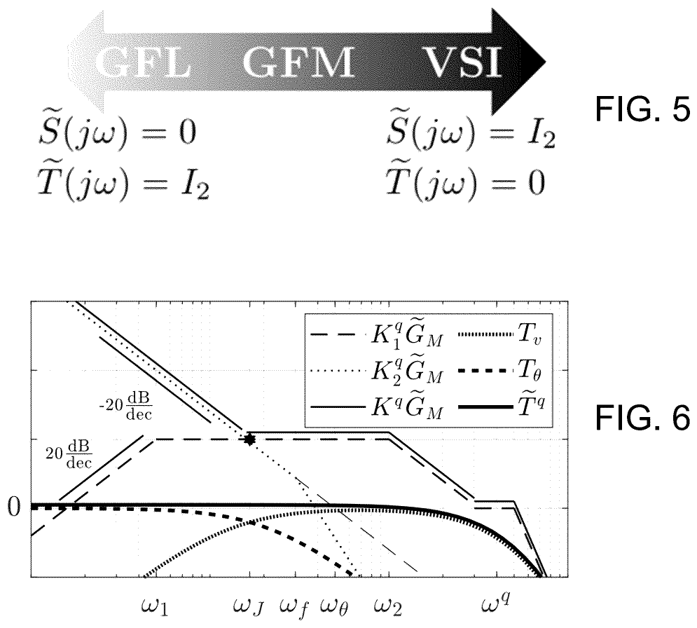

FIG. 5 is a continuum representation of a spectrum between GFL and VSI parameterized by \tilde{S} according to some embodiments. The GFM operation is based on adjusting the sensitivity \tilde{S} to achieve the desired balance between the VSI and GFL operations, as illustrated in FIG. 5. In some embodiments, a harmonic tradeoff can exist between voltage and current. An ideal PR compensator with a resonant frequency of ωₕ in \tilde{K}, leads to \tilde{S}(jωₕ)=0 and τ(jωₕ)=I₂. This shifts harmonics from line current to capacitor voltage and inverter frequency according to Equation (24). On the other hand, the notch filter in \tilde{K}, results in \tilde{S}(jωₕ)=I₂ and \tilde{T}(jωₕ)=0, shifting the harmonics from voltage and frequency to current.

In some embodiments, line-to-ground fault results in a considerable second harmonic component in grid disturbance \vec{d}. Overlooked, the disturbance can spread to the line current causing fault trip. A second-harmonic PR compensator ensures \tilde{S} (j2π120)=0 and ∥\vec{e}(j2π120)∥₂=0 in Equation (24), providing precise control of the line current at 120 Hz.

In some embodiments, a sensitivity exists between four fundamental operating modes. The inverter's operational mode is determined by how the sensitivity \tilde{S} shapes and mitigates the impact of grid disturbance \vec{d} on the current feedback error \vec{e}′ during steady-state operation. To illustrate this, consider the transfer function between the grid disturbance \vec{d} and \vec{e}′ from Equation (15) and expand \vec{d} according to the nominal disturbance model in Equation (7) to obtain

$$[ \begin{matrix}{\hat{e}}^{′ d} \\ {\hat{e}}^{′ q}\end{matrix} ] = {\tilde{G}}_{M} \tilde{S} \vec{\hat{d}} \approx {\tilde{G}}_{M} [ \begin{matrix}{\tilde{S}}^{d} & 0 \\ 0 & {\tilde{S}}^{q}\end{matrix} ] [ \begin{matrix}1 / s & 0 \\ 0 & {v}_{0} / {s}^{2}\end{matrix} ] [ \begin{matrix}Δ {v}_{g} \\ {Δω}_{g}\end{matrix} ] \qquad ( 25 )$$

Based on Equation (25), there are only four meaningful scenarios for steady-state operation. These scenarios depend on whether \tilde{S}^{d} and \tilde{S}^{q} can either completely reject grid disturbances {Δv_{g}, Δω_{g}} in Equation (25) or result in a finite gain between {Δv_{g}, Δω_{g}} and {e′^{d}, e′^{q}} during steady-state operation. In the following proposition, demonstrated herein are that these scenarios correspond to GFL, GFM, ESS and STATCOM operation, and can be characterized by the zeros of \tilde{S}^{d} and \tilde{S}^{q}.

Proposition 5.1: Inverter operating modes are determined by the number of zeros at the origin in the diagonal components of \tilde{S}, denoted by \tilde{S}^{d} and \tilde{S}^{q} in (10), as follows:
(a) GFL: If \tilde{S}^{d} has one zero and \tilde{S}^{q} includes two zeros at the origin, we achieve complete grid disturbance rejection and

$${lim}_{t \to ∞} {e}^{′ d} = 0 , {lim}_{t \to ∞} {e}^{′ q} = 0 \qquad ( 26 )$$

(b) STATCOM: If \tilde{S}^{d} has no zero and \tilde{S}^{q} includes two zeros at the origin, the inverter operates at STATCOM and

$${lim}_{t \to ∞} {e}^{′ d} = Δ {v}_{g} / ( {\tilde{G}}_{M}^{- 1} ( j 0 ) + {K}^{d} ( j 0 ) ) , {lim}_{t \to ∞} {e}^{′ q} = 0 \qquad ( 27 )$$

(c) ESS: If \tilde{S}^{d} and \tilde{S}^{q} each maintain one zero at the origin, the inverter functions as ESS and

$${lim}_{t \to ∞} {e}^{′ d} = 0 , {lim}_{t \to ∞} {e}^{′ q} = {lim}_{s \to 0} {Δω}_{g} / ( {sK}^{q} ( s ) ) \qquad ( 28 )$$

(d) GFM: If \tilde{S}^{d} has no zero at the origin and \tilde{S}^{q} has one zero at the origin, the closed-loop in FIG. 3 leads to an inherent and well-posed drooping characteristic at steady state given below

$$[ \begin{matrix}Δ {v}_{g} \\ {Δω}_{g}\end{matrix} ] = [ \begin{matrix}{\tilde{G}}_{M}^{- 1} ( j 0 ) + {K}^{d} ( j 0 ) & 0 \\ 0 & {lim}_{s \to 0} {sK}^{q} ( s )\end{matrix} ] [ \begin{matrix}{\hat{e}}^{′ d} \\ {\hat{e}}^{′ q}\end{matrix} ] \qquad ( 29 )$$

In some embodiments, the operations further include implementing droop characteristics for power sharing among parallel inverters, of the one or more inverters. Such implementing can include d-axis droop coefficients that determine voltage regulation characteristics. In embodiments, the d-axis droop coefficients are bounded by line impedance characteristics for d-axis voltage droop. Such implementing can include q-axis droop coefficients, associated with grid frequency, that determine frequency regulation characteristics. In embodiments, where the q-axis droop coefficients are bounded by a targeted frequency response bandwidth for q-axis frequency droop.

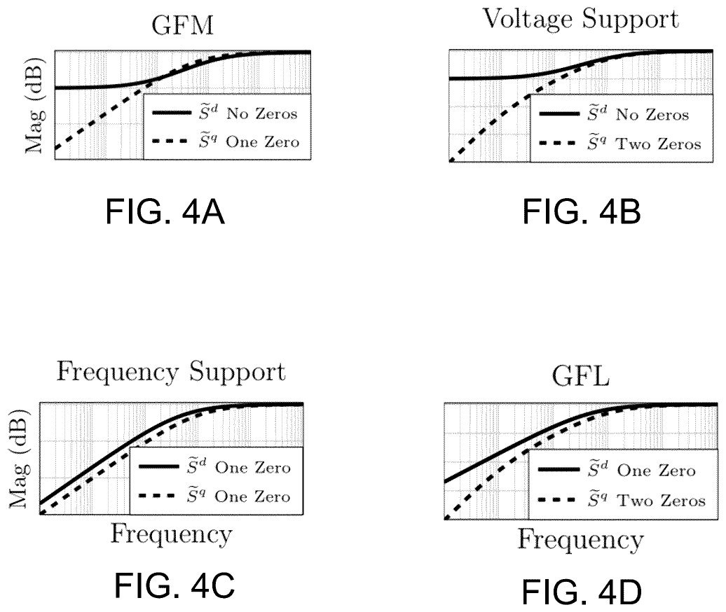

Proof 5.1: (a), (b), (c), and (d) are the direct result of application of the final value theorem to Equation (25). FIG. 4A, FIG. 4B, FIG. 4C, FIG. 4D are Bode plots illustrating inverter operating mode based on the shape and number of zeros in \tilde{S} at low-frequency in, respectively: (a) grid-forming (GFM); (b) voltage support in synchronous compensator (STATCOM); (c) frequency support in an energy storage system (ESS); and (d) grid-following (GFL). For control design, one can leverage the definition of § in Equation (10) to convert the conditions on the number of zeros, as outlined in Proposition 5.1, into an equivalent condition regarding the number of integrators in diagonal components of \tilde{K} denoted by K^{d} and K^{q}.

In various embodiments, the control relationships associated with Proposition 5.1 are summarized in Table 1 where the number of integrators (zeros at origin) in the controller determines the inverter's operating mode. The GFL mode may act like a current source, precisely tracking power commands. The GFM mode may act like a voltage source with droop characteristics, supporting grid voltage and frequency stability. The STATCOM mode may provides voltage support through reactive power exchange. The ESS mode may provide frequency support through active power exchange. Each mode represents a different balance between maintaining voltage and frequency stability versus tracking power setpoints.

TABLE 1

K^{q} (right):

| K^{d} (below): | 1 × (1/s) | 2 × (1/s) |
|---|---|---|
| 0 × (1/s) | GFM | ESS |
| 1 × (1/s) | STATCOM | GFL |

In some embodiments, the operations further include characterizing the plurality of operating modes based on a number of zeros at the origin in sensitivity transfer functions. In various embodiments, such characterization can include that a grid-following mode corresponds to one zero in a d-axis, associated with grid voltage, and two zeros in a q-axis associated with grid frequency; a grid-forming mode corresponds to no zeros in the d-axis and one zero in the q-axis; a STATCOM mode corresponds to no zeros in the d-axis and two zeros in the q-axis; and/or an ESS mode corresponds to one zero in the d-axis and one zero in the q-axis.

The more accurate term for STATCOM and ESS operation in the Proposition 5.1 is the voltage support and the frequency support, since in steady-state e′^{d} and e′^{q} are linear combinations of e^{d} and e^{q} specified by K_{L}(j0). For example, with K_{L} in Equation (22), steady-state \vec{e}′ can be illustrated as

$${\vec{e}}^{′} = {K}_{L} \vec{e} \to [ \begin{matrix}{e}^{′ d} \\ {e}^{′ q}\end{matrix} ] = [ \begin{matrix}cos {ϕ}_{z} & - sin {ϕ}_{z} \\ sin {ϕ}_{z} & cos {ϕ}_{z}\end{matrix} ] [ \begin{matrix}{e}^{d} \\ {e}^{q}\end{matrix} ] . \qquad ( 30 )$$

In this case, the nature of power transactions for voltage and frequency regulation is a combination of active and reactive power, depending on the characteristics of the line. For inductive lines (φ_{z}≈90°), one can observe conventional STATCOM and ESS operation, where voltage regulation is achieved through reactive current transactions and frequency regulation through active current transactions.

In some embodiments, power sharing exists among parallel GFM inverters. Power sharing between parallel inverters can be pursued for the sustained operation of GFM inverters with varying power ratings and to enforce the DER usage priority. Power sharing can be defined as the change in the active and reactive output power or current from the nominal set point, proportional to changes in the PCC voltage Δv_{g} and Δω_{g}. This proportion for each GFM inverter determines the sharing ratio. Based on this definition and the droop law in Equation (29) the sharing ratio between two arbitrary GFM inverters (i) and (j) is

$$\frac{{( {\tilde{G}}_{M}^{- 1} ( j 0 ) + {K}^{d} ( j 0 ) )}^{( i )}}{{( {\tilde{G}}_{M}^{- 1} ( j 0 ) + {K}^{d} ( j 0 ) )}^{( j )}} = \frac{{e}^{′ d ( j )}}{{e}^{′ d ( i )}} , {lim}_{s \to 0} \frac{{{K}^{q} ( s )}^{( i )}}{{{K}^{q} ( s )}^{( j )}} = \frac{{e}^{′ q ( j )}}{{e}^{′ q ( i )}} \qquad ( 31 )$$

In some embodiments, the d-axis sharing in Equation (31) depends on the controller K^{d} and the line impedance

$${\tilde{G}}_{M}^{- 1} .$$

However, one call reduce the effect of line impedance on power sharing and droop behavior in Equation (29) by increasing the DC gain of the controller

$${\tilde{G}}_{M}^{- 1} ( j 0 ) ≪ {K}^{d} ( j 0 ) .$$

This subsumes the concept of virtual impedance.

As mentioned earlier, the q-axis sharing in Equation (31), unlike the d-axis, depends solely on K^{q}. This allows for exact sharing of the e′^{q} component between inverters with different line impedances. However, based on the specific choice of K_{L}, e′^{q} in Equation (31) represents a linear combination of e^{d} and e^{q}. For example, K_{L}(j0) in Equation (22) results in e′^{q}=[sin φ_{z} cos φ_{z}]\vec{e}. This particular choice of K_{L} can lead to exact active power sharing only for inductive lines (φ_{z}≈90°). However, once can achieve exact active current sharing by adopting

$${K}_{L}^{*}$$

in Equation (32), which maps e′^{q} to e^{d} at steady-state, regardless of line impedance.

$${K}_{L}^{*} ( s ) = \frac{{ω}_{m}}{s + {ω}_{m}} [ \begin{matrix}\frac{L}{Z} s + cos {ϕ}_{z} & - sin {ϕ}_{z} \\ \frac{λ}{{λ}^{2} + {ω}_{0}^{2}} s + 1 & \frac{{ω}_{0}}{{λ}^{2} + {ω}_{0}^{2}} s\end{matrix} ] \qquad ( 32 )$$

The proposed

$${K}_{L}^{*}$$

satisfies stability criteria outlined in parts (a) and (b) of the Proposition 4.2, resulting in the following modified plant G_{M}* and its diagonal counterpart

$${\tilde{G}}_{M}^{*}$$

below

$${G}_{M}^{*} = \frac{{ω}_{m} / Z}{s + {ω}_{m}} [ \begin{matrix}1 & 0 \\ cos {ϕ}_{z} & sin {ϕ}_{z}\end{matrix} ] , {\tilde{G}}_{M}^{*} = \frac{{ω}_{m} / Z}{s + {ω}_{m}} [ \begin{matrix}1 & 0 \\ 0 & sin {ϕ}_{z}\end{matrix} ] . \qquad ( 33 )$$

However,

$${G}_{M}^{*} ( j 0 )$$

in Equation (33) has a suboptimal condition number of

$$κ ( {G}_{M}^{*} ( j 0 ) ) = ( 1 + cos ( {ϕ}_{z} ) ) / sin ( {ϕ}_{z} ) and for {ϕ}_{z} \leq 11 ° ,$$

(dominantly resistive line), the condition number becomes exceeds 10. This suggests that

$${K}_{L}^{*}$$

trades the robustness margin to achieve exact active power-sharing.

In some embodiments, synchronization and frequency transient responses can be explained as follows. Existing GFL and STATCOM use the PLL mechanism to synchronize their rotating frame with an established grid voltage. However, GFM and ESS synchronize through power transactions based on frequency droop. Therefore, changing between the GFL/STATCOM and GFM/ESS modes involves changing the synchronization method. In this section, we exploit the parallel structure of the q-axis controller, that is

$${K}^{q} = {K}_{1}^{q} + {K}_{2}^{q}$$

in FIG. 3 to develop a mode-independent synchronization scheme and generalize the concept of inertia and rate-of-change of frequency (RoCoF) as a closed-loop transient response. In the context of the closed-loop signals in FIG. 3 the two primary synchronization conditions are

$$\begin{matrix}( 34 ) & \\ {lim}_{t \to ∞} {Δv}_{c}^{q} = 0 , & ( a )\end{matrix}$$

$${lim}_{t \to ∞} {v}_{0} ( {\dot{θ}}_{g} - \dot{θ} ) \approx {lim}_{t \to ∞} {\dot{d}}^{q} - {u}_{θ} = 0 \qquad ( b )$$

where \dot{θ}_{g} is the time derivative of grid voltage angle (grid frequency), and \dot{θ} is the time derivative of inverter synchronous frame angle (inverter frequency). The approximation in (b) is based on definition of dq and u_{θ} in Proposition 3.1.

Condition (a) aligns the capacitor voltage phasor \vec{v}_{c} with the dq frame while (b) ensures that the rotating frame achieves frequency lock with the grid frequency \dot{θ}_{g}. Both conditions are expressed in terms of the closed-loop variables

$${Δv}_{c}^{q}$$

and u_{θ}, along with the grid disturbance dq (see FIG. 3). This allows conversion of synchronization conditions in Equation (34) into constraints for the feedback control design. To clarify, consider the transfer function between the exogenous inputs, and

$${Δv}_{c}^{q}$$

and u_{θ} as follows:

$$Δ {\hat{v}}_{c}^{q} = {T}_{v} ( \hat{w} + {\hat{d}}^{q} ) , {\hat{u}}_{θ} = {T}_{θ} ( \hat{w} + {\hat{d}}^{q} ) , \qquad ( 35 )$$

where

$$w = [ \begin{matrix}0 & 1\end{matrix} ] {G}_{M}^{- 1} \vec{{\hat{ι}}_{l}^{′}}$$

and the transfer functions Tᵥ and T_{θ} are

$${T}_{v} = \frac{{G}_{M}^{q} {K}_{1}^{q}}{1 + {G}_{M}^{q} ( {K}_{1}^{q} + {K}_{2}^{q} )} , {T}_{θ} = \frac{{G}_{M}^{q} {K}_{2}^{q}}{1 + {G}_{M}^{q} ( {K}_{1}^{q} + {K}_{2}^{q} )} . \qquad ( 36 )$$

Using final value theorem and Equation (35), Equation (34) can be converted into

$${lim}_{s \to 0} {sT}_{v} ( \hat{w} + {\hat{d}}^{q} ) = 0 , {lim}_{s \to 0} {s}^{2} ( ( 1 - {T}_{θ} ) {\hat{d}}^{q} - {T}_{θ} \hat{w} ) = 0 \qquad ( 37 )$$

In some embodiments, the operations include implementing mode-independent synchronization by maintaining synchronization conditions across the plurality of operating modes by ensuring capacitor voltage alignment with a direct-quadrature (dq) reference frame and achieving a frequency lock between the inverter and a grid frequency.

FIG. 6 is a Bode plot illustrating operations of desired q-axis closed-loops Tᵥ, T_{θ}, \tilde{T}^{q}, and corresponding open-loops

$${K}_{1}^{q} {\tilde{G}}_{M} , {K}_{2}^{q} {\tilde{G}}_{M}$$

and K^{q}\tilde{G}_{M} according to some embodiments. The equation above allows us to formulate the synchronization in terms of the conditions on the controllers

$${K}_{1}^{q} Kq and {K}_{2}^{q} .$$

Proposition 5.2: We achieve synchronization, regardless of the operating mode, if

$$( {K}_{1}^{q} / {K}_{2}^{q} )$$

includes at least two zeros at the origin and

$${K}_{2}^{q}$$

has at least one pole at the origin.

Proof 5.2: Adopting the nominal ramp model in Equation (7) for d^{q} and considering

$${T}_{v} = {T}_{θ} {K}_{1}^{q} / {K}_{2}^{q} ,$$

Equation (37) is rewritten as follows

$${lim}_{s \to 0} s \frac{{K}_{1}^{q}}{{K}_{2}^{q}} {T}_{θ} ( \hat{w} + {v}_{0} \frac{{Δω}_{g}}{{s}^{2}} ) = 0 , {lim}_{s \to 0} {v}_{0} ( 1 - {T}_{θ} ) {Δω}_{g} - {s}^{2} {T}_{θ} \hat{w} = 0.$$

Based on the conditions in the proposition lim_{s→0}T_{θ}=1, lims→0 Tθ=1, and

$${lim}_{s \to 0} {K}_{1}^{q} / ( {s}^{2} {K}_{2}^{q} ) = c o n s t ,$$

completing the proof. In some embodiment, the synchronization is achieved by configuring a first q-axis controller with at least two zeros at the origin relative to a second q-axis controller and the second q-axis controller with at least one pole at the origin.

1) Transient response of Inverter Frequency: T_{θ} in Equation (36) represents the closed-loop transfer function between the inverter's frequency deviation Δω, and the grid frequency deviation Δω_{g}. Therefore, the characteristics of T_{θ}, such as the bandwidth, generalize the concepts of inertia and RoCoF, while the peak of T_{θ}, denoted as M_{T}=∥T_{θ}∥_{∞}, is directly proportional to the overshoot (frequency nadir) and the transient oscillation of Δω. Therefore, it is desired to shape T_{θ} as a unity gain low-pass filter with M_{T}<3 dB, and low bandwidth. However, there are two sources of difficulties. First, the transient frequency response, the current and the voltage regulation objectives on the q axis are interdependent and conflicting. Second, shaping T_{θ} and Tᵥ in (36) to achieve the desired closed-loop objectives requires the concurrent design of both

$${K}_{1}^{q} and {K}_{2}^{q}$$

We establish the design criteria for

$${K}_{1}^{q} and {K}_{2}^{q}$$

considering the fundamental algebraic constraints outlined below

$${T}_{θ} + {T}_{v} = {\tilde{T}}^{q} , {\tilde{S}}^{q} + {\tilde{T}}^{q} = {\tilde{S}}^{q} + ( {T}_{θ} + {T}_{v}^{q} ) = 1 \qquad ( 38 )$$

where \tilde{T}^{q} is the closed-loop variable between the current setpoint

$${i}_{0}^{′ q} and {i}_{g}^{′ q} g .$$

We aim to keep e\tilde{T}^{q} close to one and \tilde{S}^{q} small over a broad frequency range [0, ω^{q}] to achieve effective disturbance rejection in Equation (15), negligible tracking error in Equation (24), dynamic decoupling in Equation (11), and MIMO stability (Proposition 4.1(c)). Furthermore, T_{θ} in Equation (36) should be designed as a low-pass filter with a bandwidth ω_{J}<<ω^{q} to achieve an inertial response, low RoCoF, and to attenuate the effect of high-frequency grid disturbances on Δω. Based on Equation (38), this automatically constrains Tᵥ to a unity gain band-pass filter between ω_{J} and ω_{q} as shown in FIG. 6. In the following, we sketch the outline of the open-loops M that result in the desired T_{θ}, Tᵥ and \tilde{T}^{q} Subsequently, in Section VI-A, we provide an example control design for

$${K}_{1}^{q} and {K}_{2}^{q} .$$

In some embodiments, the operations further include implementing virtual inertia control by shaping a frequency response transfer function as a low-pass filter with adjustable bandwidth and damping characteristics to control: a rate of change of frequency (RoCoF) between the inverter and the grid-tied line; and frequency nadir following disturbances bypassing a reliance on mimicking synchronous generator dynamics.

$${K}_{1}^{q} {\tilde{G}}_{M} :$$

should be designed as a bandpass filter with a gain cross-over frequency near ω_{q} and a phase margin of 60°. The pass band should satisfy ω_{J}∈[ω₁, ω₂], as shown in FIG. 6, where ω_{J} is the bandwidth of T_{θ} and adjusts the desired inertial response. The ratio ω_{J}/ω₁ is directly proportional to M_{T} and damps and reduces the frequency nadir and oscillation. Finally, the filter should achieve slope of −20 dB/dec at low frequency to satisfy synchronization condition in Proposition 5.2.

$${K}_{2}^{q} {\tilde{G}}_{M} :$$

should be shaped close to an integrator (e.g., ω_{θ}/s) that intersects

$${K}_{1}^{q} {\tilde{G}}_{M}$$

at ω_{J} in the pass band region, as shown in FIG. 6. To attenuate the effect of high-frequency disturbances on inverter frequency, we augment the open-loop with a low-pass filter with cut-off frequency ω_{f} above ω_{J}.

Hereinafter is disclosed a feedback control design for \tilde{K} that meets the stability and performance criteria proposed in this disclosure. Subsequently, we implement the proposed control design using inverter closed-loop dynamics. For the control design, assume the nominal line impedance of Z∠φ_{z}, and adopt K_{L} in Equation (22) and the corresponding \tilde{G}_{M} in (23) to satisfy the coupling stability in Proposition 4.2. Subsequently, for

$$\tilde{K} = diag ( {K}^{d} , {K}_{1}^{q} + {K}_{2}^{q} )$$

we employ the following set of controllers

$$\begin{matrix}{K}^{d} = \frac{s + {ω}_{m}}{{ω}_{m} / Z} ( \frac{s + {α}_{v}}{s + 2 \sqrt{2} ( α Z ) {β}_{v}} ) {( \frac{\sqrt{2} {ω}_{d}}{s + {ω}_{d}} )}^{3} ( \frac{s + α {ω}_{d}}{α s + {ω}_{d}} ) \\ {K}_{1}^{q} = \frac{s + {ω}_{m}}{{ω}_{m} / Z} ( \frac{\sqrt{{ω}_{q}^{2} + {ω}_{2}^{2}} s}{( s + {ω}_{1} ) ( s + {ω}_{2} )} ) {( \frac{\sqrt{2} {ω}_{q}}{s + {ω}_{q}} )}^{2} ( \frac{s + α {ω}_{q}}{α s + {ω}_{q}} ) \\ {K}_{2}^{q} = \frac{s + {ω}_{m}}{{ω}_{m} / Z} ( \frac{{ω}_{θ}}{s} ) ( \frac{s + {α}_{θ} / {ω}_{θ}}{s + {β}_{θ} Z} ) ( \frac{{ω}_{f}}{s + {ω}_{f}} )\end{matrix} \qquad ( 39 )$$

We justify the proposed control parameters and design by considering their dynamic and steady-state characteristics as follows.

1) d-axis: Droop characteristics: Based on Equation (29), the steady-state voltage droop coefficient for K^{d} in (39) is

$${\tilde{G}}_{M}^{- 1} + {K}^{d} ( j 0 ) = Z + \frac{{α}_{v}}{{β}_{θ}} , max \{ \frac{{α}_{v}}{a Z} , \frac{4 ( a Z )}{\sqrt{2}} {β}_{v} \} << {ω}_{d} . \qquad ( 40 )$$

The voltage droop depends on the ratio αᵥ/βᵥ. Higher values of αᵥ and βᵥ correspond to faster zero and pole in Equation (39) and quicker droop responses. We recommend limiting αᵥ and βᵥ by the d-axis open-loop bandwidth as indicated in (40).

Dynamic characteristics: Given that inequality in Equation (40) holds, K^{d} in (39) leads to an open-loop

$${K}^{d} {G}_{M}^{d}$$

with a gain crossover frequency of close to ω_{d} and phase margin

$$P M \approx 45 + arc sin ( 1 - a ) / ( 1 + a ) , 0 \leq a \leq 1 \qquad ( 41 )$$

2) q-axis: Droop characteristics: Based on (29), the steady-state frequency droop coefficient for K^{q} in Equation (39) is

$${lim}_{s \to 0} {sK}^{q} = {lim}_{s \to 0} s ( {K}_{1}^{q} + {K}_{2}^{q} ) = \frac{{α}_{θ}}{{β}_{θ}} , max \{ \frac{{α}_{θ}}{{ω}_{θ}} , {β}_{θ} \} << {ω}_{J} \qquad ( 42 )$$

We limit α_{θ} and β_{θ} by ω_{J} in (42), where ω_{J} represents the bandwidth for T_{θ} to achieve desired inertia.

Dynamic characteristics

$${K}_{1}^{q} and {K}_{2}^{q}$$

in Equation (39) satisfy the synchronization condition in Proposition 5.2. Furthermore, for ω₁<ω₂<<ω^{q} the shape of

$${K}_{1}^{q} {\tilde{G}}_{M}$$

traces the desired shape shown in FIG. 6, with a gain cross-over frequency of ω^{q} and a phase margin close to PM≈arcsin(1−a)/(1+a). The proposed

$${K}_{2}^{q}$$

in Equation (39), includes an integrator ω_{θ}/s, lowpass filter with a cut-off frequency of ω_{f}(ω_{J}<ω_{f}) to attenuate the disturbance in the inverter frequency, and a compensator to shape the drooping characteristics. The resulting

$${K}_{2}^{q} {\tilde{G}}_{M}$$

intersects the pass band region of

$${K}_{1}^{q} {\tilde{G}}_{M}$$

at ω_{J}∈[ω₁, ω₂] provided that ω_{θ} satisfies the constraint

$$log ( {ω}_{J} ) - log ( {ω}_{2} ) \approx log ( {ω}_{θ} ) - log ( a {ω}_{q} ) , ⇔ {ω}_{θ} \approx \frac{{ω}_{q}}{a {ω}_{2}} {ω}_{J} . \qquad ( 43 )$$

This allows us to calculate ω_{θ} for the desired inertial bandwidth ω_{J}. Finally, by adjusting ω₁, we can fine-tune the ratio of ω_{J}/ω₁ for the desired damping of the frequency oscillation.

3) PR compensator for enhanced stability: Proposition 9.1 imposes an upper-bound on the 2-SISO sensitivity \tilde{S} to ensure stability in the presence of the nonlinear term ψ(⋅, ⋅) in line dynamics.

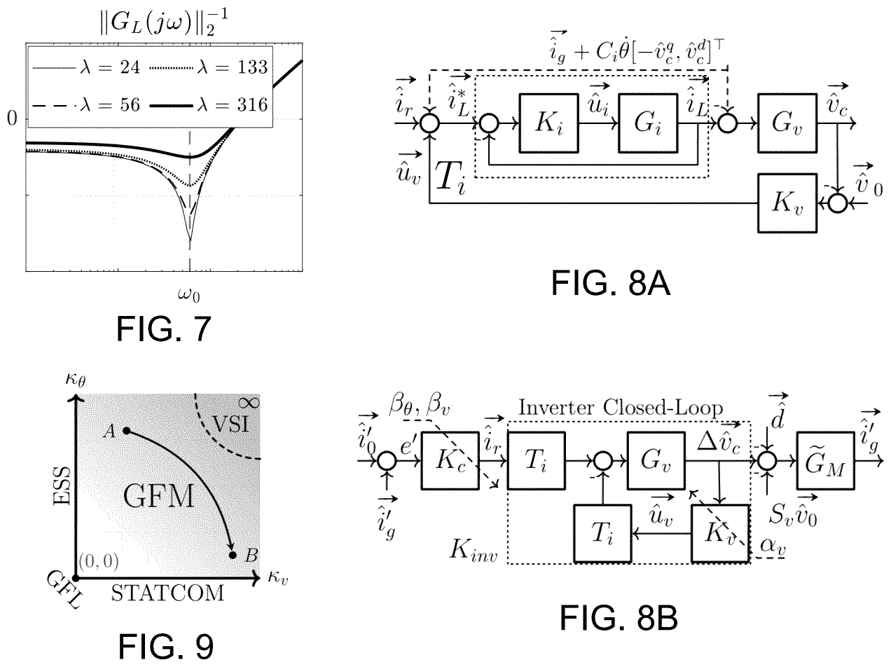

FIG. 7 is a Bode plot illustrating smaller values of λ, which impose stricter upper-bounds on sensitivity around the fundamental frequency ω_{θ} according to at least one embodiment. This upper bound is explicitly dependent on ∥G_{L}(jω)∥⁻¹, where the shape of G_{L}(jω) is uniquely determined by the line characteristics, denoted by λ=R/L. As shown in FIG. 7, smaller values of Δ result in a significant notch in ∥G_{L}(jω)∥⁻¹ at the fundamental frequency ω₀. Consequently, this requires the 2-SISO sensitivity transfer function \tilde{S} to be small at ω0. In embodiments, the sensitivity transfer function \tilde{S}(jω) denotes the current error signal (e.g., tracking error) relative to the desired current setpoint at frequency ω, which can be understood as an algebraic difference between the setpoint and the measured output relative to setpoint at given frequency ω. Thus, \tilde{S}(jω)=(\hat{r}(jω)−ŷ(jω))/\hat{r}(jω)), where \hat{r}(jω) is the setpoint or reference signal value at frequency ω and ŷ(jω) is the measured process variable, e.g., actual frequency actual voltage, actual power output component at frequency ω. Based on the definition of \tilde{S} in Equation (10), we can reduce \tilde{S} at ω0 by cascading a proportional resonant compensator (PR) in series K^{d} and

$${K}_{1}^{q}$$

controllers in Equation (39). An example of a PR compensator is given below

$${K}_{PR} = 1 + {k}_{{ω}_{0}} \frac{2 {ζω}_{0} s}{{s}^{2} + 2 {ζω}_{0} s + {ω}_{0}^{2}} , ζ = \frac{{Δω}_{max}}{{ω}_{0}} \qquad ( 44 )$$

where k_{ω}_{₀} sets the PR gain and Δωₘₐₓ represents the maximum expected frequency deviation from nominal value.

We simplified closed-loop analysis and design by neglecting the dependence of K^{d} and

$${K}_{1}^{q}$$

on the inverter closed-loop dynamics. In the following discussion related to FIGS. 8A-8B, discussed is how to use inverter dynamics to implement K^{d} and

$${K}_{1}^{q} .$$

In some embodiments, an inverter closed-loop can function as a feedback compensator as follows. We adopt the cascaded closed-loop structure in FIG. 8A with inner current and outer voltage loops. Here, Gᵢ=1/(Lᵢs+Rᵢ) and Gᵥ=1/(Cᵢs) represent the dynamics of the inductor and capacitor in Equation (5). To form the inner closed loop, we use feedback linearization to decouple the inductor dynamics in Equation (5) by defining the modulation signal as

$$\vec{m} = \frac{2}{{v}_{dc}} ( {\vec{u}}_{ι} + {\vec{v}}_{c} + {L}_{i} {\dot{θ} [ - {i}_{L}^{q} , {i}_{L}^{d} ]}^{⊤} ) \qquad ( 45 )$$

where \vec{u_{ι}} denotes the output of current controller Kᵢ in FIG. 8A. Subsequently, we use the proportional-integral (PI) controller Kᵢ=ω_{c}(Lᵢs+Rᵢ)/s to shape the inner closed-loop Ti in FIG. 8A into a unity gain low-pass filter with cut-off frequency ω_{c} below

$${T}_{i} = \frac{{G}_{i} {K}_{i}}{1 + {G}_{i} {K}_{i}} = \frac{{ω}_{c}}{s + {ω}_{c}} , and {S}_{i} = 1 - {T}_{i} = \frac{s}{s + {ω}_{c}} \qquad ( 46 )$$

The operations can further include implementing, as part of the unified algebraic control system, a cascaded closed-loop structure with an inner current loop and an outer voltage loop, as illustrated in FIGS. 8A-8B. The operations can include using feedback linearization to decouple inductor dynamics of an inductor and a capacitor being modeled within the inner current loop and employing a phase interpolator controller to shape the inner current loop into a unity gain low-pass filter.

Specifically, FIG. 8A and FIG. 8B are circuit diagrams illustrating, respectively, (a) nested structure with voltage and current inputs; and (b) inverter closed-loop as part of feedback compensator. The outer voltage loop is formed by setting the reference,

$$\vec{{ι}_{L}^{*}} ,$$

for the inner closed-loop as follows

$$\vec{{ι}_{L}^{*}} = \vec{{ι}_{r}} + \vec{{u}_{v}} + \vec{{ι}_{g}} + {C}_{i} {\dot{θ} [ - {v}_{c}^{q} , {v}_{c}^{d} ]}^{⊤} \qquad ( 47 )$$

where \vec{uᵥ} is the output of the voltage compensator Kᵥ and \vec{ιᵣ} is the input to the cascaded closed-loop as shown in FIG. 8A. The feed-forward term

$$\vec{{ι}_{g}} + {C}_{i} {\dot{θ} [ - {v}_{c}^{q} , {v}_{c}^{d} ]}^{⊤}$$

decouples the capacitor dynamics and counteracts the effect of grid current in (5). The proposed cascaded closed-loop in FIG. 8A leads to the following relation between the inputs {\vec{v₀}, \vec{ιᵣ}, \vec{ι_{g}}}\vec{\hat{v}_{c}}

$$\vec{{\hat{v}}_{c}} = {G}_{v} {S}_{v} ( {T}_{i} \vec{{\hat{l}}_{r}} + {T}_{i} {K}_{v} \vec{{\hat{v}}_{0}} - {S}_{i} ( \vec{{\hat{ι}}_{g}} + {C}_{i} {\dot{θ} [ - {v}_{c}^{q} , {v}_{c}^{d} ]}^{⊤} ) ) \qquad ( 48 )$$

where {Sᵢ, Tᵢ} are given by Equation (46), and Sᵥ is the sensitivity transfer function for the voltage closed-loop defined below

$${S}_{v} = [ \begin{matrix}{S}_{v}^{d} & 0 \\ 0 & {S}_{v}^{q}\end{matrix} ] [ \begin{matrix}{( 1 + {G}_{v} {T}_{i} {K}_{v}^{d} )}^{- 1} & 0 \\ 0 & {( 1 + {G}_{v} {T}_{i} {K}_{v}^{q} )}^{- 1}\end{matrix} ] . \qquad ( 49 )$$

For a large value of ω_{c}, Sᵢ in (48) remains small over a broad frequency range and can be assumed to be negligible. Therefore, considering Δ\vec{v_{c}}=\vec{v_{c}}−\vec{v₀}, we can rewrite (48) as

$$Δ \vec{{\hat{v}}_{c}} = {K}_{inv} {{ι}^{\vec{ˆ}}}_{r} - {S}_{v} \vec{{\hat{v}}_{0}} where {K}_{i n v} = {G}_{v} {S}_{v} {T}_{i} \qquad ( 50 )$$

In some embodiments, Kᵢₙᵥ captures the inverter closed-loop dynamics as a compensator between \vec{ιᵣ} and Δ\vec{v_{c}} as shown in FIG. 8B. Kᵢₙᵥ can represent any transfer function with a relative degree of at least two and the following zpk (zeros (z), poles (p) and gain (k)) form

$${K}_{i n v} = \frac{N ( s )}{D ( s )} = \frac{{ω}_{c}}{{C}_{i}} \frac{( s + {z}_{n} ) … ( s + {z}_{0} )}{( s + {p}_{m} ) … ( s + {p}_{0} )} , n \leq ( m - 2 ) \qquad ( 51 )$$

if voltage compensator Kᵥ=Nᵥ(s)/Dᵥ(s) is designed as

$${N}_{v} ( s ) = D ( s ) - {C}_{i} s ( s + {ω}_{c} ) N ( s ) / {ω}_{c} , {D}_{v} ( s ) = N ( s ) \qquad ( 52 )$$

and the inner closed-loop controller Kᵢ is set to

$${K}_{i} = {ω}_{c} \frac{{L}_{i} s + {R}_{i}}{s} where \qquad ( 53 )$$

$${ω}_{c} = {\sum }_{i = 0}^{m} {p}_{i} - {\sum }_{i = 0}^{n} {z}_{i}$$

where pᵢ and zᵢ are poles and zeros of transfer function Kᵢₙᵥ in Equation (51). We can cascade Kᵢₙᵥ with a series compensator Kc to form the feedback compensator between \vec{e}′ and Δ\vec{v_{c}} shown in FIG. 8B. In this case, comparing FIG. 3 and FIG. 8B shows

$${K}_{c} {K}_{i n v} = [ \begin{matrix}{K}_{c}^{d} {K}_{i n v}^{d} & 0 \\ 0 & {K}_{c}^{q} {K}_{i n v}^{q}\end{matrix} ] = [ \begin{matrix}{K}^{d} & 0 \\ 0 & {K}_{1}^{q}\end{matrix} ] \qquad ( 54 )$$

Equation (53) indicates that poles and zeros of the controllers K^{d} and

$${K}_{1}^{q}$$

should be divided between K_{c} and Kᵢₙᵥ. We suggest that the inverter dynamics Kᵢₙᵥ only includes the smallest zero and three of the largest poles of K^{d} and

$${K}_{1}^{q}$$

and K_{c} include rest of poles and zeros. For example, K^{d} and

$${K}_{1}^{q}$$

in (39) can be divided into Kᵢₙᵥ and K_{c} as follows

$${K}_{i n v}^{d} = \frac{{ω}_{c}^{d}}{{C}_{i}} \frac{s + {α}_{v}}{{( s + {ω}_{d} )}^{3}} , {K}_{i n v}^{q} = \frac{{ω}_{c}^{q}}{{C}_{i}} \frac{s}{( s + {ω}_{2} ) {( s + {ω}_{q} )}^{2}} \qquad ( 55 )$$

$${K}_{c}^{d} = \frac{{C}_{i}}{{ω}_{c}^{d}} ( \frac{2 \sqrt{2} {ω}_{d}^{3}}{{ω}_{m} / Z} ) ( \frac{s + {ω}_{m}}{s + 2 \sqrt{2} ( a Z ) {β}_{v}} ) ( \frac{s + a {ω}_{d}}{a s + {ω}_{d}} ) \qquad ( 56 )$$

$${K}_{c}^{q} = \frac{{C}_{i}}{{ω}_{c}^{q}} ( \frac{2 {ω}_{q}^{2} \sqrt{{ω}_{q}^{2} + {ω}_{2}^{2}}}{{ω}_{m} / Z} ) ( \frac{s + {ω}_{m}}{s + {ω}_{1}} ) ( \frac{s + a {ω}_{q}}{a s + {ω}_{q}} ) \qquad ( 57 )$$

where

$${ω}_{c}^{d} = 3 {ω}_{d} - {α}_{v} and {ω}_{c}^{q} = 2 {ω}_{q} - {ω}_{2} .$$

Finally, we implement Kᵢₙᵥ in (55) by designing Kᵥ and Kᵢ as

$${K}_{v}^{d} = {C}_{i} \frac{( 3 {ω}_{d}^{2} + {α}_{v} {ω}_{c}^{d} ) s + {ω}_{d}^{3}}{{ω}_{c}^{d} ( s + {α}_{v} )} , {K}_{i}^{d} = {ω}_{c}^{d} \frac{{L}_{i} s + {R}_{i}}{s} \qquad ( 58 )$$

$${K}_{v}^{q} = {C}_{i} \frac{( {ω}_{q}^{2} + 2 {ω}_{2} ) s + {ω}_{2} {ω}_{q}^{2}}{{ω}_{c}^{q} s} , {K}_{i}^{q} = {ω}_{c}^{q} \frac{{L}_{i} s + {R}_{i}}{s} \qquad ( 59 )$$

according to Equation (52) and Equation (53).

1) Generating the rotating angle: Based on the Proposition 3.1, the control signal u_{θ} from

$${K}_{2}^{q}$$

encodes the dq rotating angle θ. Therefore, in practice, u_{θ} is implemented indirectly through θ as follow

$$θ ( t ) = {ω}_{0} t + \frac{1}{{v}_{0}} {u}_{θ} ( t ) ( mod 2 π ) \qquad ( 60 )$$

In some embodiments, disclosed include seamless transitions between operating modes. FIG. 9 is multi-dimensional graph illustrating operating space of a multi-operational mode power grid parameterized by variable pair (κᵥ, κ_{θ}) according to some embodiments. Variables of this variable pair can be defined as κᵥ=βᵥ/αᵥ and κ_{θ}=β_{θ}/α_{θ}, where αv, βv and αθ, βθ are the parameters in Equation (39). The (κᵥ, κ_{θ}) pair can define a 2D steady-state operating space, as shown in FIG. 9. The y-axis (κᵥ=0) corresponds to an integrator in K^{d}, while the x-axis (κ_{θ}=0) corresponds to two integrators in K^{q}. According to Table I, the y-axis represents the ESS mode, the x-axis represents STATCOM operation, and the origin represents GFL mode. Moreover, each point within this 2D space specifies a unique combination of operating modes; for example, point A in FIG. 9 is closer to the ESS mode, while point B is closer to STATCOM operation.

Changing κ=(κᵥ, κ_{θ}) allows seamless transitions between operating modes, as shown in FIG. 9. The secondary control layer can leverage the mode transitions to create a flexible and adaptive system that aligns with economic or dispatch goals in a dynamic environment. Although the controller in Equation (39) ensures stability in each mode (pointwise stability), one can also ensure stability during mode transition, given a sufficiently slow change in the parameters κ=(κᵥ, κ_{θ}). This two-dimensional operating space can be visualized as a map where each point represents a different inverter behavior. Moving smoothly between points (e.g., changing κv and κθ) allows the inverter to transition between modes without discontinuous jumps that could cause grid disturbances. For example, gradually reducing both parameters toward zero can shift the inverter from grid-forming toward grid-following mode.

In some embodiments, controlling the transitions includes adjusting the pair of closed-loop variables along trajectories in a control parameter space, starting and ending at setpoints, of the plurality of setpoints, corresponding respectively to an initial mode and a final mode of the plurality of operating modes. In embodiments, the pair of closed-loop variables include an inverter variable and a grid state variable, which are implemented as a control input and a disturbance using a direct quadrature formulation. The κv and κθ parameters can serve as the pair of closed-loop variables controlling transitions along trajectories in the 2D parameter space.

Proposition 6.1: Pointwise stability at each operating mode κ=(κᵥ, κ_{θ}) is a sufficient condition to ensure the stability of the closed-loop system during mode transitions, provided that the parameters κ=(κᵥ, κ_{θ}) change slowly enough.

Proof 6.1: The seamless transition between operational modes involves the adjustment of controller parameters K, which results in a closed-loop LPV system. We guarantee the stability of the closed-loop, shown in FIG. 3, during mode transitions by limiting the rate of change of parameters. To begin, we rewrite the closed-loop system in (79) in the following form:

$$\frac{d}{d t} x = ( A ( κ ) - B {K}_{min} C ) x + B {u}_{ψ} , \qquad ( 61 )$$

$${u}_{ψ} = ψ ( t , y ) + {K}_{min} y = - {ψ}_{*} ( t , y ) \qquad ( 62 )$$

where x=[x_{g}xₖ]^{τ} and {A, B, C} triplet are defined as

$$A ( κ ) = [ \begin{matrix}{A}_{g} + {D}_{k} & {C}_{k} \\ - {B}_{k} & {A}_{k} ( κ )\end{matrix} ] , B = [ \begin{matrix}{I}_{2} \\ 0\end{matrix} ] , C = [ {I}_{2} 0 ] \qquad ( 63 )$$

Moreover, the transformed feedback nonlinearity ψ_{*}(⋅, ⋅) in (62) belongs to the sector [0, K_{*}], where K_{*}=Kₘₐₓ−Kₘᵢₙ=2I₂Δωₘₐₓ (see Equation (81) and Equation (82)).

The system in Equation (61) can have the following transfer matrix realization

$${G}_{L} {S ( {I}_{2} + {K}_{min} {G}_{L} S )}^{- 1} := [ \begin{matrix}{A}_{*} & B \\ C & 0\end{matrix} ] \qquad ( 64 )$$

where A_{*}=A(κ)−BKₘᵢₙC. If Z(s) in Equation (83) is strictly positive real (SPR), then there exist a positive definite matrix W, matrix L and a positive constant 0<n such that {A_{*}, B, C} satisfy

$$W {A}_{*} + {A}_{*}^{T} W = - {L}^{T} L - nW \qquad ( 65 )$$

$$WB = {C}^{T} {K}_{*} - \sqrt{2} {L}^{T} \qquad ( 66 )$$

One can adopt the Lyapunov function v(x)=x^{T}W(κ)x for the system in (61) where W is the same as (65). The time derivative of v(x) along the trajectories of x(t) is

$$\dot{v} ( x ) = {x}^{T} ( \dot{W} ( κ ) - {L}^{T} L - n W ) x - 2 {x}^{T} W B {ψ}_{*} ( t , y ) \qquad ( 67 )$$

The nonlinearity ψ_{*}(⋅, ⋅) belongs to the sector [0, K_{*}] therefore we add the positive term −2ψ_{*}(t, y)^{τ}(ψ_{*}(t, y)−K_{*}y)>0 to the right-hand side of (67) to get the following inequality

$$\dot{v} ( x ) \leq {x}^{T} \dot{W} ( κ ) x - {x}^{T} {L}^{T} L x - 2 {ψ}_{*}^{T} ( t , y ) {ψ}_{*} ( t , y ) + 2 {x}^{T} ( {C}^{T} {K}_{*} - WB ) {ψ}_{*} ( t , y ) - n v ( x ) \qquad ( 68 )$$

Based on Equation (66), we complete the square term above to get

$$\dot{v} ( x ) \leq {x}^{T} \dot{W} ( κ ) x - {x}^{T} {M}^{T} M x - n v ( x ) \qquad ( 69 )$$

where Mx is defined below

$$M x = L x - \sqrt{2} {ψ}_{*} ( t , y ) = ( L - \sqrt{2} Δω [ \begin{matrix}0 & 1 \\ - 1 & 0\end{matrix} ] C ) x \qquad ( 70 )$$

We apply Grönwall's inequality to demonstrate that the Lyapunov function \dot{v}(x) and the closed-loop trajectories remain bounded and stable during the transition. To achieve this, we need to bound \dot{v}(x) in terms of v(x). This is accomplished by applying two consecutive bounds to Equation (69), as shown below

$$\dot{v} ( x ) \leq {x}^{T} \dot{W} ( κ ) x - n v ( x ) \leq q ( t ) v ( x ) \qquad ( 71 )$$

The term q(t) is defined below by directly applying the Rayleigh-Ritz theorem to x^{T}\dot{W}x.

$$q ( t ) = \frac{ρ ( \dot{W} ( κ ) )}{\underline{λ} ( W ( κ ) )} - n \qquad ( 72 )$$

In above ρ(⋅) is the spectral radius, and λ(⋅) indicates smallest eigenvalue. Employing the Grönwall's inequality, we get the following bound on closed-loop trajectories

$$v ( t , x ) = {x}^{T} W x \leq v ( 0 , {x}_{0} ) exp ( {\int }_{0}^{t} q ( μ ) d μ ) \qquad ( 73 )$$

Based on the above, the sufficient condition for Lyapunov stability is the convergence of the exponential term to zero. Therefore, q(t)<0 provides a sufficient condition for stability. We convert this condition into an upper bound on the rate of change of {κᵥ, κ_{θ}} through the following three operations:

In Equation (72), we express \dot{W} as \dot{κ}ᵥ∂W/∂κᵥ+\dot{κ}_{θ}∂W/∂κ_{θ}, where the partial derivatives are applied element-wise.

The matrices ∂W/∂κᵥ and ∂W/∂κ_{θ} are symmetric, and for symmetric matrices, the spectral radius ρ(⋅) is equal to ∥⋅∥₂. The matrix two-norm is sub additive.

Based on Equation (72) and the three steps outlined above, the following condition is sufficient to ensure q(t)<0.

$$[ \vert {\dot{κ}}_{v} \vert \vert {\dot{κ}}_{θ} \vert ] [ \begin{matrix}{‖ \partial W ( κ ) / \partial {κ}_{v} ‖}_{2} \\ {‖ \partial W ( κ ) / \partial {κ}_{θ} ‖}_{2}\end{matrix} ] \leq \underline{λ} ( W ( κ ) ) n \qquad ( 74 )$$

For small {\dot{κ}ᵥ, \dot{κ}_{θ}} we can satisfy the above inequality since the right-hand side is always defined and positive.

TABLE II
Simulation and Experimental Parameters

| Parameter | Sym. | Sim. | | Expt. | | Parameter | Sym. | Value | |
|---|---|---|---|---|---|---|---|---|---|
| Filter | Cᵢ | 15 | μF | 15 | μF | Grid voltage | υ_{g} | 120 | V |
| capacitor | | | | | | (line-RMS) | | | |
| Filter | Lᵢ | 1 | mH | 470 | μH | Fundamental | ω_{g} | 60 | Hz |
| inductor | | | | | | Frequency | | | |
| Grid | L | 1 | mH | 470 | μH | Switching | f_{aw} | 50 | kHz |
| inductor | | | | | | frequency | | | |
| Grid | R | 1 | mΩ | 1.4 | mΩ | Sampling | fₐ | 50 | kHz |

| | |
|---|---|
| resistance | Frequency |

The following disclosure covers simulation and experimental results. We demonstrate the salient features of the proposed system through hardware-in-the-loop (HIL) simulation and experiment. The simulations are carried out using the OPAL-RT real-time platform; as for the experimental results, we used a set of three-phase inverters to assume the rule of GFM, GFL, and power grid. In both cases, the control algorithms are implemented in the TI TMS320F28388D digital signal processor (DSP).

### On Grid Operation

In this section, we investigate the performance of the proposed GFM inverter in grid-tied operation. We assess the accuracy of active and reactive current injection in two scenarios: first, when the grid operates at nominal voltage and frequency; and second, when the grid experiences disturbances causing deviations from the nominal voltage and frequency. Furthermore, we explore the transient response of the GFM to step changes in grid voltage and frequency and demonstrate the inverter's ability to achieve an inertia-like response. Subsequently, we demonstrate a seamless transition scenario in which a group of grid-tied inverters provide ancillary services to the grid through a mode switch. Lastly, we showcase the robustness of the inverter to uncertainties in line impedance by operating it under conditions where the line impedance differs significantly from the nominal value. This steps is essential to guarantee operation of the inverter under weak grid conditions.

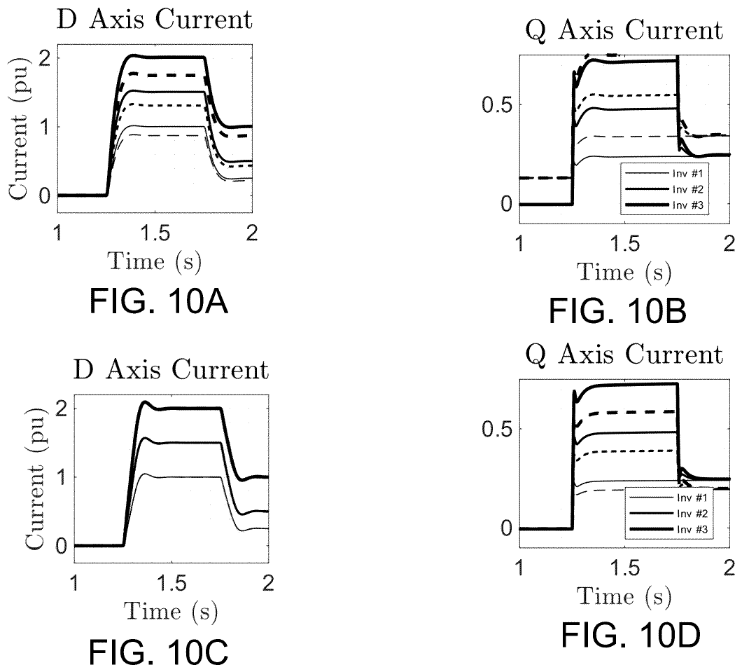

FIG. 10A, FIG. 10B, FIG. 10C, and FIG. 10D are graphs of current over time during nominal grid operation, respectively: (a) active current with and without set-point adjustment; (b) reactive current in a complex line scenario; (c) active current with adjusted current set-point; and (d) reactive current in inductive line scenario according to various embodiments. Nominal grid operation: Based on the above disclosure, proposed GFM inverter can inject active and reactive currents into the grid with zero steady-state error, provided two conditions are met: 1) the grid operates at nominal voltage and frequency; and 2) the inverter's current set-point is determined using the modified current set-point

$$\vec{{ι}_{0}^{*}} = {K}_{L}^{- 1} \tilde{T} {K}_{L} \vec{{ι}_{0}} .$$

Solid lines in FIG. 10A and FIG. 10B demonstrate group of three inverters successfully tracking the exact current set-points in case of complex line impedance. The dashed lines in these figures represent the deviation of the active and reactive current of the inverter if the set-point was not adjusted according to modified set-point.

The adjusted current set-point is based on knowledge of the line impedance. However, in the case of a purely inductive line, where cos φ_{z}=0, the precise injection of active current does not depend on the value of the line impedance. FIG. 10c shows precise active current injection for both adjusted and unadjusted current set-point. However, as shown in FIG. 10d, in the purely inductive line the reactive current deviates for the unadjusted current set-point.

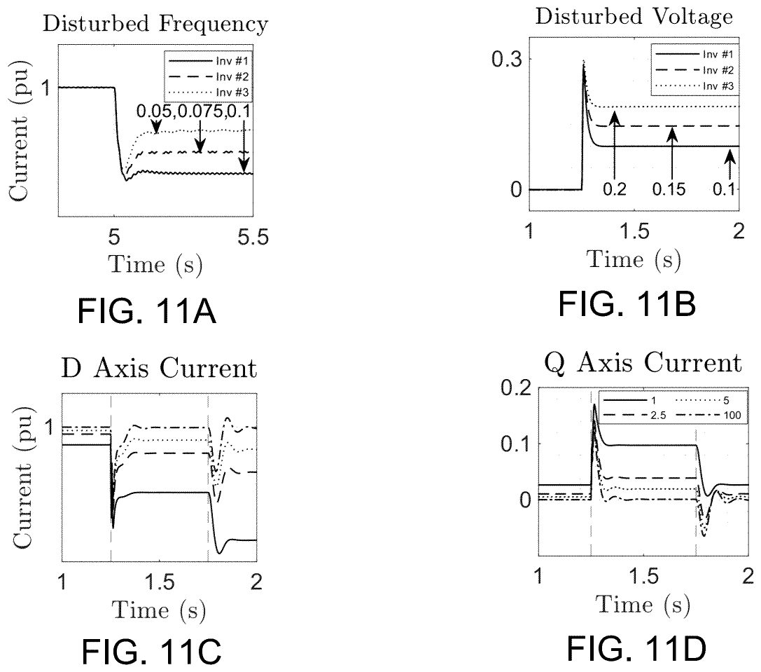

FIG. 11A, FIG. 11B, FIG. 11C, FIG. 11D are graphs of current over time during disturbed grid operation, respectively: (a) active current with and without set-point adjustment under grid frequency disturbance; (b) reactive current deviation under grid volage disturbance; (c) improving active current with adjusted current set-point; and (d) improving reactive current in inductive line scenario by decreasing the sensitivity transfer function according to various embodiments. Disturbed grid operation: When the voltage and frequency of the grid deviate from the nominal values, the GFM output current shifts away from its target set point. In the case of a predominantly inductive line, the deviation in active and reactive currents is independently determined by the droop characteristics of the GFM q-axis and d-axis controllers, respectively, as well as by the value of the line impedance. FIG. 11A and FIG. 11B shows how a set of three inverters reacts to deviations of 0.1 pu in voltage and 0.1 Hz in frequency within the grid. These Figures clearly demonstrate that the magnitude of these deviations from the intended set-points is directly proportional to the droop characteristics of the d and q controllers of each GFM inverter.

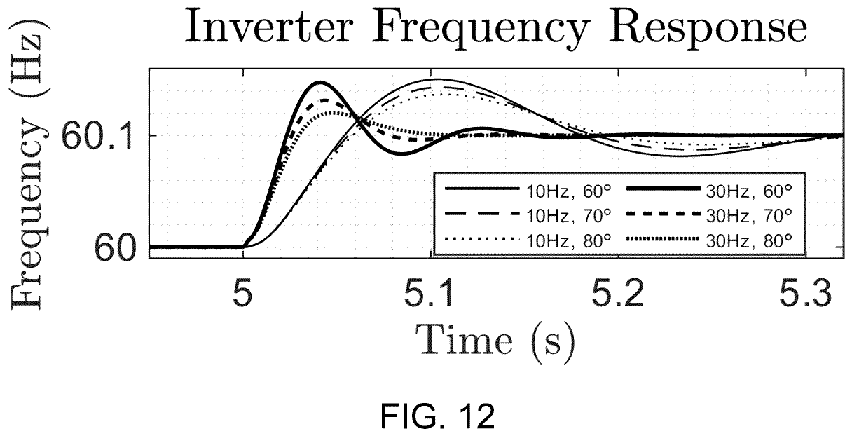

FIG. 12 is a graph of a frequency response of the inverter to step change of magnitude 0.1 Hz in grid frequency according to at least one embodiment. Increasing the bandwidth of T_{θ} leads to faster response while increasing the phase margin reduce the oscillation. Improving accuracy of current injection: Based on Equation (24) and Equation (25), we can improve the accuracy of steady-state current set-point tracking by reducing the sensitivity transfer function S at low frequencies. This improvement holds irrespective of any disturbances in grid voltage and frequency or changes in line impedance. Lowering the sensitivity transfer function can be achieved by reducing the values of βᵥ, β_{θ} towards zero. Doing so moves the operating mode closer to the origin in FIG. 9, indicative of a pronounced Grid-Following (GFL) operation. FIG. 11C and FIG. 11D show rapid improvement in active and reactive current set-points tracking under complex line impedance and grid voltage and frequency disturbances at t=1.25 and t=1.75 for smaller values of {βᵥ, β_{θ}}.

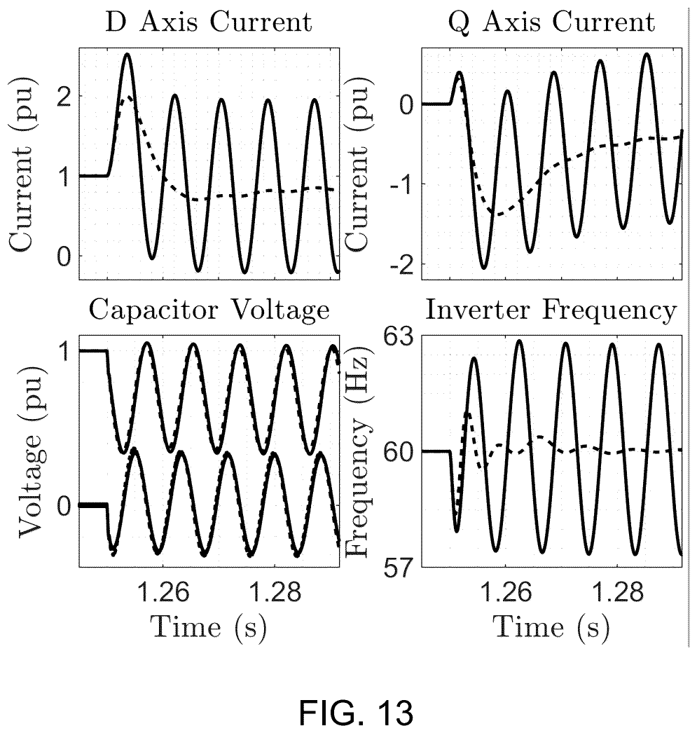

FIG. 13 is a set of graphs illustrating how a proposed GFM control system effectively rejects a 120 Hz ripple caused by line-to-ground fault on inverter current and frequency according at least one embodiment. This facilitates the fault ride through.

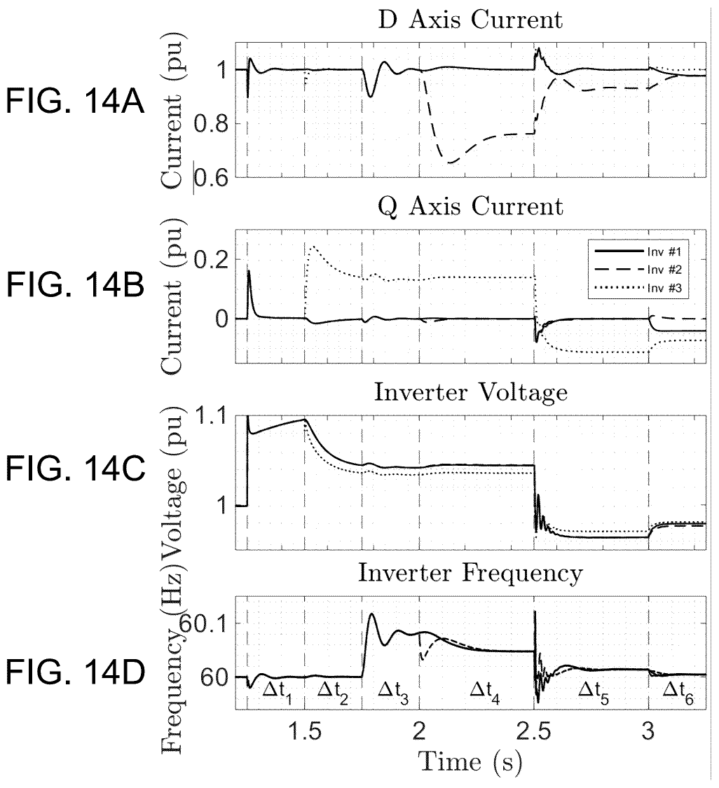

FIG. 14A, FIG. 14B, FIG. 14C, FIG. 14D are graphs illustrating, respectively, d-axis current, q-axis current, inverter voltage, and inverter frequency of a seamless transition of the set of inverters during on-grid operation at particular moments outline in Table III according to some embodiments, wherein “pu” stands for per unit.

TABLE III
Statue of Inverters and Power Grid

| | Δt₁ | Δt₂ | | Δt₃ | | Δt₄ | | Δt₅ | Δt₆ |
|---|---|---|---|---|---|---|---|---|---|
| inv 1 | GFL | GFL | | GFL | | GFL | | GFL | GFM |
| inv 2 | GFL | GFL | | GFL | | ESS | | ESS | ESS |
| inv 3 | GFL | STAT | | STAT | | STAT | | STAT | STAT |
| Δv_{g} | 0.1 (pu) | 0.1 | pu | 0.1 | pu | 0.1 | pu | Off- Grid | |
| Δw_{g} | 0 Hz | 0 | Hz | 0.1 | Hz | 0.1 | Hz | | |

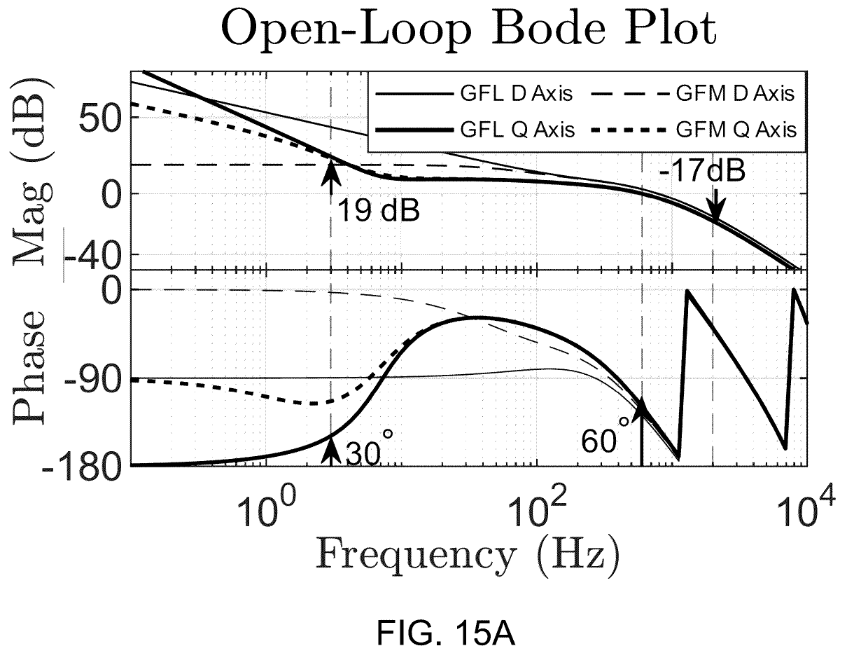

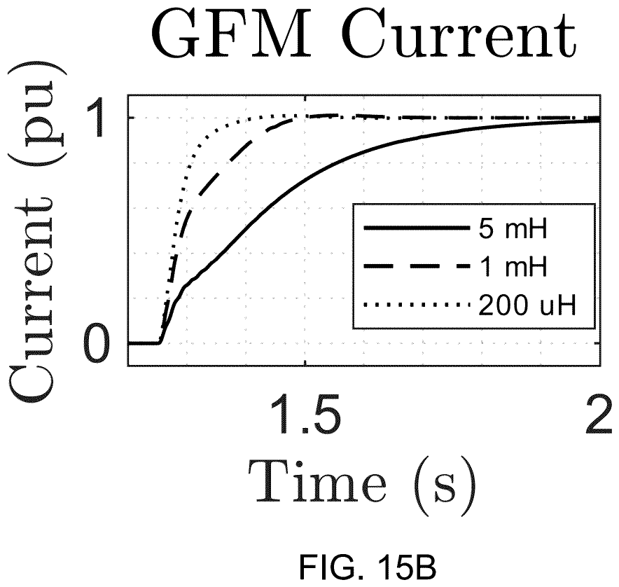

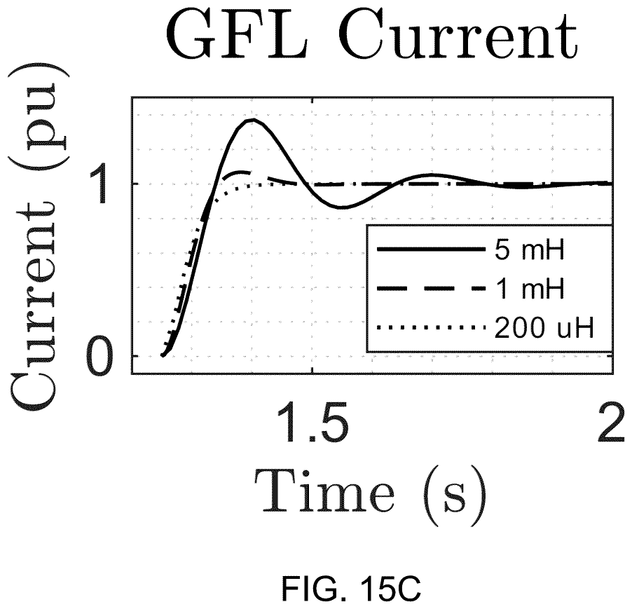

FIG. 15A, FIG. 15B, FIG. 15C are graphs illustrating, respectively, (a) a Bode plot for d-axis and q-axis open-loops under GFM and GFL operation; (b) GFM response to step-change in active current set-point under line impedance variation; and (c) GFL response to step-change in active current set-point under line impedance variation according to some embodiments.

Inverter Inertial Frequency Response: According to previously explanation, we can adjust the inverter frequency response to grid frequency disturbances. This adjustment can be made regardless of the operating mode, only by modifying the bandwidth and phase margin of T_{θ}. In FIG. 12 we illustrate that the frequency response of the GFM inverter to the step change in the grid frequency varies with different bandwidths and phase margins for T_{θ}. Clearly, a higher bandwidth results in a quicker response time, whereas a greater phase margin reduces oscillations in the inverter's frequency during transients.

Line-to-Ground Fault: In the event of a line-to-ground fault, there is a risk of a significant current surge in the affected phase, which can cause damage to the equipment or trigger circuit breakers. This issue is particularly challenging for traditional GFM and VSI, which lack the precise current control capabilities of GFL inverters within the closed-loop bandwidth. However, as previously discussed, we can enhance the GFM control to operate as a GFL at the determined frequency by making the 2-SISO sensitivity transfer function \tilde{S} small at that frequency. Given that a line-to-ground fault introduces a second harmonic disturbance into the system, integrating a proportional resonant (PR) compensator tuned to 2ω0 (double the fundamental frequency) into the feedback loop enables the GFM inverter to precisely control current and reject disturbances at this specific frequency.

FIG. 13 shows that the proposed GFM inverter continues to operate smoothly during a fault, effectively rejecting the 120 Hz ripple on both the inverter output current and frequency. This is a drastic improvement over conventional GFM, shown by the dashed line in the graphs of FIG. 13. Note that in both cases, the voltage regulation is compromised to accommodate for fault-ride-through. In embodiments, the operations further include compensating for line-to-ground fault conditions by incorporating proportional-resonant (PR) compensators tuned to second harmonic frequency to maintain current control during fault conditions. For example, the PR compensator at 2ω0 enables fault ride-through.

Seamless Transition and Ancillary Service: The proposed inverter control is designed to smoothly transition between the GFL, GFM, STATCOM, and ESS modes. To evaluate the seamless transition, we initially operate a set of three inverters in GFL mode connected to a stiff grid. However, in the event of a contingency, the voltage and frequency of the grid deviate from the nominal value. Under given circumstances, we provide an ancillary service to the grid by transitioning one of the inverters to ESS for frequency support and another inverter to STATCOM to assist with voltage correction. This adjustment effectively mitigates deviations in the voltage and frequency of the grid, bringing them closer to their nominal values. In the last stage of the experiment, we assessed the system's response to sudden islanding. During islanding, both the ESS and STATCOM intervene to stabilize the frequency and voltage of the newly formed islanded grid. We further enhance the voltage and frequency stability of the islanded microgrid by switching the last GFL to GFM operation. We have detailed the statue of the inverters and the grid in the Table III. Additionally, FIG. 14 illustrates the effectiveness of proposed controllers, showing a smooth transition and satisfactory transient response during key moments outlined in Table III. In embodiments, at least one inverter operates in grid-forming mode to establish voltage and frequency reference, and the remaining inverters operate in grid-following, STATCOM, or ESS modes based on ancillary service requirements.

Robustness to Line Impedance Variation: Proposed control design ensures robustness to changes in the line impedance. The Bode plots in FIG. 15a show that we consistently achieve a 60° phase margin and a 17 dB gain margin for both d and q open-loops regardless of mode of operation. Based on the definition of the modified plant in (23), this means that we can handle a decrease in the magnitude of the line impedance Z by a factor of 7 (19 dB). Conversely, increasing the magnitude of Z does not cause instability in any mode of operation. However, it is crucial to note that the phase for the q open-loop in GFL mode approaches 180° at lower frequencies. This implies that lowering the open-loop gain in the q axis not only reduces the closed-loop bandwidth but also leads to a smaller phase margin and increased oscillatory behavior. For example, a reduction of 19 dB in the gain of the q axis yields a new open-loop with a crossover frequency of 3 Hz and a phase margin of approximately 30°, as illustrated in FIG. 15A. In our final demonstration of the robust stability, we design the controller for the nominal line impedance of L_{g}=1 mH. Subsequently, we examine the closed-loop's response to a unit step change in the active current set-point across three different line impedances: L_{g}=5 mH, L_{g}=1 mH, and L_{g}=200 μH. The results in FIG. 15B and FIG. 15C show that the system operates stably in all three scenarios. However, there is a noticeable decrease in bandwidth when the inductance values are higher, and oscillatory behavior is observed in the GFL operation.

### Off Grid Operation

The proposed control design enables a collection of inverters to establish an islanded microgrid if at least one inverter is set to operate in GFM mode or if the group includes at least one STATCOM and one ESS inverter.

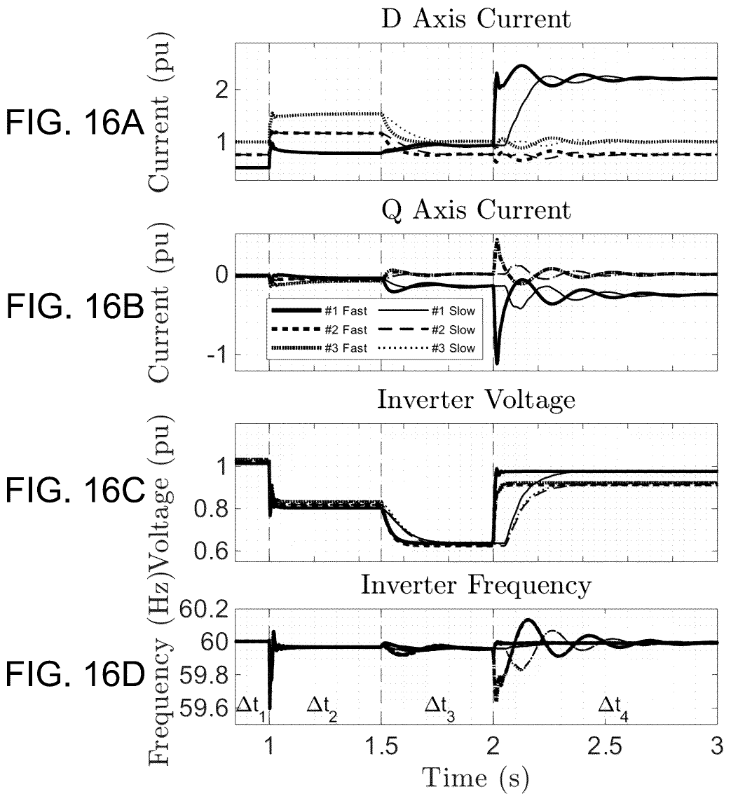

FIG. 16A, FIG. 16B, FIG. 16C, FIG. 16D are graphs illustrating, respectively, d-axis current, q-axis current, inverter voltage, and inverter frequency of a seamless transition of the set of inverters during on-grid operation at particular moments outline in Table IV according to some embodiments. A system for coordinated control of multiple inverters in a microgrid can include a plurality of inverters, each implementing the unified control framework, power sharing ratios determined by relative droop coefficients, mode assignment based on grid strength and power balance requirements, and seamless transition capability for individual inverters without affecting others.

Seamless Transition and Power Sharing: We assess the seamless transition and power sharing in islanded operation by initially operating a set of three inverters in GFM mode with sharing ratios of γ₁=0.22, γ₂=0.33, γ₃=0.45. Next, we doubled the resistive load and found that the inverters continued to share power effectively, though, as anticipated, this caused a droop in voltage. We then switched two of the inverters to GFL operation, which led to a further reduction in voltage. In the final step, by converting the remaining GFM inverter to an ideal VSI, we enhanced both the voltage and the frequency stability. Additionally, we demonstrate that slowing the rate at which the operational mode changes can minimize transients. The details of the grid are given in Table III. In embodiments, the operations include implementing a seamless transition between grid-connected and islanded operation without implementing control reconfiguration, islanding detection schemes, or communication-based coordination.

TABLE IV
Statue of inverters and load.

| | γ | i^{d}₀ | i^{d}₀ | Δt₁ | Δt₂ | Δt₃ | Δt₄ |
|---|---|---|---|---|---|---|---|
| inv 1 | 0.22 | 0.5 pu | 0 pu | GFM | GFM | GFM | VSI |
| inv 2 | 0.33 | 0.75 pu | 0 pu | GFM | GFM | GFL | GFL |
| inv 3 | 0.45 | 1 pu | 0 pu | GFM | GFM | GFL | GFL |

| | | | | |
|---|---|---|---|---|
| Resistive Load | 1 pu | 2 pu | 2 pu | 2 pu |

Proposition 9.1: In practice, inverters must operate reliably despite uncertainties: the actual line impedance may differ from assumed values, grid frequency varies during disturbances, and measurement noise affects control signals. The following analysis establishes mathematical bounds that guarantee stable operation despite these uncertainties. The central challenge is that frequency variations create nonlinear coupling between the d and q axes-imagine two pendulums connected by a spring where the spring stiffness varies with time. We handle this by (i) bounding the maximum expected frequency deviation (Δωₘₐₓ), (ii) treating the nonlinearity as a “sector-bounded” disturbance (contained within known limits), and (iii) deriving conditions on the controller that ensure stability for all disturbances within these bounds. This approach provides hard guarantees rather than just typical-case performance. The closed-loop system in FIG. 3 maintains stability under the effect of nonlinear term ψ_{*(}t, \vec{y}) in line dynamics of Equation (3) if (a) inverter frequency is bounded as (\dot{θ}−ω₀)∈[−Δωₘₐₓ, Δωₘₐₓ], (b) G_{L}S is stable, and (c) the following bound on 2-SISO sensitivity \tilde{S} holds

$${‖ \tilde{S} ( j ω ) ‖}_{2} < \frac{{‖ {Γ𝒳}_{c} ‖}_{2}^{- 1}}{Δ {ω}_{max}} {‖ {G}_{L} ( j ω ) ‖}_{2}^{- 1} , ∀ ω \qquad ( 75 )$$

Proof 9.1: Assume that the line dynamics G_{L} and the feedback controller κ=\tilde{K}K_{L}, as depicted in FIG. 3, are represented by the following state-space realization:

$$\frac{d}{d t} {x}_{g} = {A}_{g} {x}_{g} - ψ ( t , {y}_{g} ) + {y}_{k} , {y}_{g} = {x}_{g} \qquad ( 76 )$$

$$\frac{d}{d t} {x}_{k} = {A}_{k} {x}_{k} - {B}_{k} {y}_{g} , {y}_{k} = {C}_{k} {x}_{k} + {D}_{k} {y}_{g} \qquad ( 77 )$$

where {Aₖ, Bₖ, Cₖ, Dₖ} in Equation (77) represent the minimal realization of controller K. Moreover, A_{g} and ψ(⋅, ⋅) in Equation (76) denote the state-matrix and the nonlinear dynamic below

$${A}_{g} = [ \begin{matrix}- \frac{R}{L} & {ω}_{0} \\ - {ω}_{0} & - \frac{R}{L}\end{matrix} ] , ψ ( t , {y}_{g} ) = Δ ω ( t ) [ \begin{matrix}0 & - 1 \\ 1 & 0\end{matrix} ] [ \begin{matrix}{y}_{g}^{d} \\ {y}_{g}^{q}\end{matrix} ] \qquad ( 78 )$$

Our primary objective is to ensure the stability of the closed-loop in FIG. 3, represented by the line and controller dynamics in Equation (76) and Equation (77), in the presence of nonlinear dynamics ψ(⋅, ⋅). To establish a stability condition, we first reformulate the dynamics in Equation (76) and Equation (77) as the following LTI system

$$\frac{d}{d t} [ \begin{matrix}{x}_{g} \\ {x}_{k}\end{matrix} ] = [ \begin{matrix}{A}_{g} + {D}_{k} & {C}_{k} \\ - {B}_{k} & {A}_{k}\end{matrix} ] [ \begin{matrix}{x}_{g} \\ {x}_{k}\end{matrix} ] + [ \begin{matrix}{I}_{2} \\ 0\end{matrix} ] {u}_{ψ} \qquad ( 79 )$$

$$y = [ {I}_{2} 0 ] [ \begin{matrix}{x}_{g} \\ {x}_{k}\end{matrix} ]$$

with the nonlinear feedback law.

$${u}_{ψ} = - ψ ( t , y ) \qquad ( 80 )$$

By representing the nonlinear line dynamics as the feedback nonlinearity in Equation (80), we can establish a sufficient stability condition using a sector-boundedness argument.

The nonlinear element ψ(t, y) belongs to the sector [Kₘᵢₙ, Kₘₐₓ] if

$${[ ψ ( t , y ) - {K}_{min} y ]}^{T} [ ψ ( t , y ) - {K}_{max} y ] \leq 0 , ∀ t \qquad ( 81 )$$

Assuming the maximum allowable deviation in the inverter's frequency from the nominal value is bounded as follow

$${ω}_{0} - Δ {ω}_{max} < \dot{θ} < {ω}_{0} + Δ {ω}_{max} \qquad ( 82 )$$

then Kₘₐₓ=I₂Δωₘₐₓ and Kₘᵢₙ=−I₂Δωₘₐₓ provide one such sector bound for ψ(⋅, ⋅) in Equation (78). Now we are ready to present the stability condition.

Take G(s) as the transfer matrix realization of the state space model in Equation (79), then the sufficient conditions for the stability of the system in Equation (79) with the nonlinear feedback law in Equation (80) are as follows: G(s)(I₂−ΔωₘₐₓG(s))⁻¹(a) is stable, (b) Z(s) below is strictly positive real (SPR)

$$Z ( s ) = ( {I}_{2} + Δ {ω}_{max} G ( s ) ) {( {I}_{2} - Δ {ω}_{max} G ( s ) )}^{- 1} \qquad ( 83 )$$

We can simplify the stability of G(s)(I₂−ΔωₘₐₓG(s))⁻¹ and the SPR condition for Z(s) into the following sufficient conditions, which will be more useful for control design

$$Δ {ω}_{max} {‖ G ( j ω ) ‖}_{∞} < 1 \qquad ( 84 )$$

and G(s) is stable. We demonstrate the sufficiency of the above condition by examining the three SPR conditions for Z(s), assuming that (84) holds [20].

(a) The plot of det[I₂−ΔωₘₐₓG(jω)] neither goes through nor circles the origin under the condition in Equation (84). Hence, by the multivariate Nyquist criterion, G(s)(I₂−ΔωₘₐₓG(s))⁻¹ and subsequently Z(s) is Hurwitz.

(b) Z(jω)+Z^{τ}(−jω) is positive definite for all ω if (84) holds. Consider the following factorization

$$Z ( j ω ) + {Z}^{T} ( - j ω ) = 2 {( {I}_{2} - {Δω}_{max} {G}^{T} ( - j ω ) )}^{- 1} \times ( {I}_{2} - {Δω}_{max}^{2} {G}^{T} ( - j ω ) G ( j ω ) ) \times {( {I}_{2} - Δ {ω}_{max} G ( j ω ) )}^{- 1} \qquad ( 85 )$$

Based on factorization above Z(jω)+Z^{τ}(−jω)>0 for all ω if and only if

$${σ}_{min} ( {I}_{2} - Δ {ω}_{max}^{2} {G}^{T} ( - j ω ) G ( j ω ) ) > 0 , ∀ ω ∈ ℝ \qquad ( 86 )$$

where σₘᵢₙ is the smallest singular value. Note that this is indeed the case since 1−(Δωₘₐₓ∥G(jω)∥_{∞})²>0 fulfills following lower-bound

$${σ}_{min} ( {I}_{2} - Δ {ω}_{max}^{2} {G}^{T} ( - j ω ) G ( j ω ) ) > 1 - {( Δ {ω}_{max} {‖ G ( j ω ) ‖}_{∞} )}^{2} .$$

(c) For strictly proper G(s) we have

$$Z ( ∞ ) + {Z}^{T} ( ∞ ) = 2 {I}_{2} > 0 \qquad ( 87 )$$

To establish practical design criteria for the feedback controller, we need to explicitly express G(s) in Equation (84) in terms of the relevant closed-loop transfer functions of FIG. 3. This can be done by noting that G_{L}S has the same state-space realization as (79), or simply G(s)=G_{L}S. Consequently, we can convert Equation (84) into a condition on the magnitude of the closed-loop sensitivity as follows:

$${‖ S ( j ω ) ‖}_{2} < \frac{1}{Δ {ω}_{max}} {‖ {G}_{L} ( j ω ) ‖}_{2}^{- 1} , ∀ ω \qquad ( 88 )$$

As the final operation, we replace S with its factorization in terms of S from Proposition 3.2 to get the desired result in Equation (75). This robustness condition ensures the inverter remains stable even when the actual grid impedance differs from the assumed value, enabling weak grid operation. This limiting/bounding relates three factors: (1) how much coupling exists between d and q axes, (2) the maximum expected frequency deviation, and (3) the line impedance characteristics. Meeting this condition guarantees stable operation across a wide range of grid conditions. In some embodiments, a method for ensuring robust stability of grid-connected inverters under line impedance variations includes designing controllers for nominal line impedance; establishing gain and phase margins sufficient to handle impedance variations; implementing sensitivity shaping to bound coupling effects; and verifying stability through spectral radius conditions on closed-loop transfer matrices.

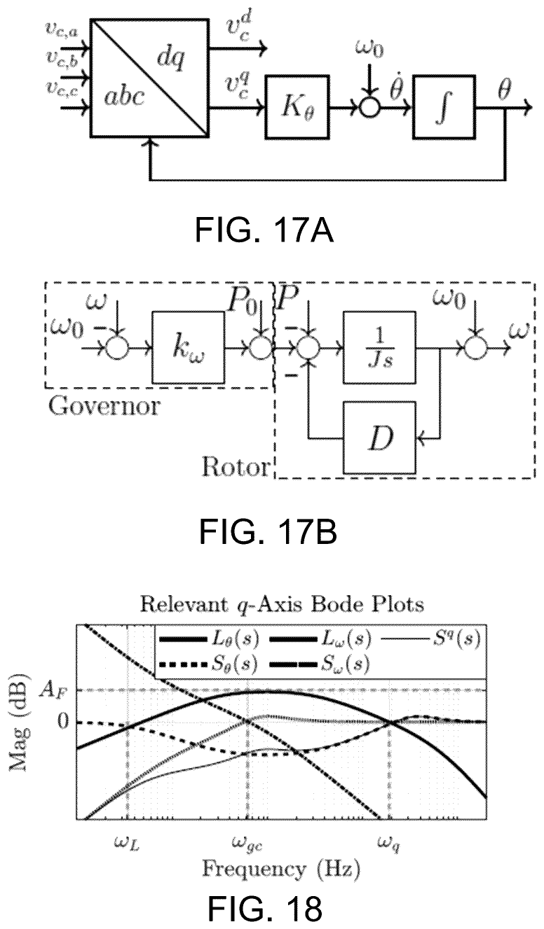

This disclosure has demonstrated a seamless transition between different operating modes. The final step toward a truly unified inverter control system is to introduce a common synchronization mechanism. GFL-based and STATCOM-based systems typically synchronize with the grid voltage using the PLL, as shown in FIG. 17A, while GFM and ESS synchronize using a frequency droop scheme, such as a virtual inertia method shown in FIG. 17B, to achieve power synchronization. Consequently, switching between GFL/STATCOM and GFM/ESS modes has traditionally required changing the synchronization strategy.

To address this, we leverage the parallel structure of the q-axis controller,

$${K}^{q} = {K}_{1}^{q} + {K}_{2}^{q} ,$$

in FIG. 3 and apply a disturbance rejection system to develop a mode-independent synchronization approach. This method also generalizes the concepts of inertia and the rate-of-change of frequency (RoCoF) by interpreting them as properties of the closed-loop transient response.

### Synchronization as Disturbance Rejection

The following are general synchronization conditions that hold irrespective of mode of operation:

$$\begin{matrix}( a ) & \\ {lim}_{t \to ∞} Δ {v}_{c}^{q} = 0 , & ( 89 )\end{matrix}$$

$$\begin{matrix}( b ) & \\ {lim}_{t \to ∞} {v}_{0} ( {\dot{θ}}_{g} - \dot{θ} ) = 0. & \end{matrix}$$

Condition (a) ensures that the capacitor voltage phasor \vec{v}_{c} aligns with the d-axis in FIG. 2B, forcing

$${v}_{c}^{q} = 0.$$

As a result, the following mapping between active/reactive power and the dq currents becomes decoupled:

$$[ \begin{matrix}{i}_{0}^{d} \\ {i}_{0}^{q}\end{matrix} ] = \frac{2 / 3}{{‖ \vec{{υ}_{c}} ( t ) ‖}^{2}} [ \begin{matrix}{υ}_{c}^{d} & {υ}_{c}^{q} \\ {υ}_{c}^{q} & - {υ}_{c}^{d}\end{matrix} ] [ \begin{matrix}{P}_{0} \\ {Q}_{0}\end{matrix} ] . \qquad ( 90 )$$

Condition (b) ensures that the dq rotating frame achieves frequency lock with the grid frequency \dot{θ}_{g}. In this work, we use condition (b) expressed in terms of the input disturbance d^{q} and the control effort u_{θ} from FIG. 3 as follows:

$${lim}_{t \to ∞} {υ}_{0} ( ( {\dot{θ}}_{g} - {ω}_{0} ) - ( \dot{θ} - {ω}_{0} ) ) = {lim}_{t \to ∞} \frac{d}{d t} ( {υ}_{0} \int Δ {ω}_{g} - Δ ω d t ) \approx {lim}_{t \to ∞} \frac{d}{d t} ( {d}^{q} - {u}_{θ} ) \qquad ( 91 )$$

Here, the final approximation follows from the definitions of d^{q} and u_{θ} in (12) and (13).

To convert synchronization conditions in (89) into closed-loop control design criteria, we apply the final value theorem to part (a) of (89) and the equivalent of condition (b) from (91), yielding:

$$\begin{matrix}( a ) {lim}_{s \to 0} s Δ {\hat{υ}}_{c}^{q} = 0 , & ( b ) {lim}_{s \to 0} {s}^{2} ( {\hat{d}}^{q} - {\hat{u}}_{θ} ) = 0.\end{matrix} \qquad ( 92 )$$

Referring to the closed-loop block diagram in FIG. 3 and related closed-loop error dynamic, the following relations hold between the exogenous inputs, {î′^{q}, \hat{d}′^{q}}, and

$$\{ Δ {\hat{υ}}_{c}^{q} , {\hat{u}}_{θ} \} :$$

$$Δ {\hat{υ}}_{c}^{q} = {K}_{1}^{q} {\hat{e}}^{′ q} = {T}_{ω} ( {K}_{1}^{q} / {K}_{2}^{q} ) ( {\hat{i}}_{0}^{′ q} / {G}_{M}^{q} + {\hat{d}}^{q} ) , \qquad ( 93 )$$

$${\hat{u}}_{θ} = {K}_{2}^{q} {\hat{e}}^{′ q} = {T}_{ω} ( {\hat{i}}_{0}^{′ q} / {G}_{M}^{q} + {\hat{d}}^{q} ) , \qquad ( 94 )$$

where the transfer function T_{ω} is given by:

$${T}_{ω} = {G}_{M}^{q} {K}_{2}^{q} {S}^{q} = \frac{{G}_{M}^{q} {K}_{2}^{q}}{1 + {G}_{M}^{q} ( {K}_{1}^{q} + {K}_{2}^{q} )} , \qquad ( 95 )$$

Substituting

$$Δ {\hat{υ}}_{c}^{q}$$

and û_{θ} from (93) and (94) into the Laplace-domain synchronization conditions in (92) yields:

$$( a ) {lim}_{s \to 0} {sT}_{ω} ( {K}_{1}^{q} / {K}_{2}^{q} ) ( {\hat{i}}_{0}^{′ q} / {G}_{M}^{q} + {\hat{d}}^{q} ) = 0 , \qquad ( 96 )$$

$$( b ) {lim}_{s \to 0} {s}^{2} ( ( 1 - {T}_{ω} ) {\hat{d}}^{q} - {T}_{ω} {\hat{i}}_{0}^{′ q} / {G}_{M}^{q} ) = 0 , \qquad ( 97 )$$

which reformulates the synchronization requirements in terms of T_{ω} from (95) and the ratio of feedback controllers

$${K}_{1}^{q} / {K}_{2}^{q} .$$

Although these expressions may appear complex, they result in a simple synchronization condition, expressed purely in terms of

$${K}_{1}^{q} and {K}_{2}^{q} .$$

Proposition 7.1: Synchronization is achieved for any operating mode if

$${K}_{2}^{q}$$

includes at least one pole at the origin (i.e., one integrator), and the ratio of two parallel q-axis controllers

$${K}_{1}^{q} / {K}_{2}^{q} ,$$

has at least two zeros at the origin.

### B. Inertia, RoCoF and Frequency Transient Response

The transient characteristics of an inverter's frequency response are commonly evaluated using two key metrics: the frequency nadir, ω_{nadir}, and the rate of change of frequency (RoCoF), both measured following a disturbance such as a sudden change in load. These metrics are formally defined as:

$$\begin{matrix}Δ {ω}_{n a d i r} = {max}_{t > {t}_{0}} \vert ω ( {t}_{0} ) - ω ( t ) \vert , & {RoCoF}_{T} \approx \frac{ω ( T + {t}_{0} ) - ω ( {t}_{0} )}{T} ,\end{matrix} \qquad ( 98 )$$

where t₀ represents the instant of the disturbance, and T is the time window for the calculation of the RoCoF, which typically varies from 100 to 500 ms [30].

In the disclosed system, T_{ω} in (95) is the transfer function between the grid's frequency deviation Δω_{g} and inverter's frequency deviation Δω:

$$Δ \hat{ω} = {T}_{ω} Δ {\hat{ω}}_{g} . \qquad ( 99 )$$

As a result, the step-response characteristics of T_{ω}, such as the peak time tₚ and the maximum overshoot Mₚ, naturally generalize key concepts such as RoCoF, inertia and frequency nadir for the inverter system.

To shape the transient response and meet specific inertia and RoCoF requirements, we use the loop-shaping technique. We start by expressing T_{ω} from (73) in closed-loop form, where the corresponding loop transfer function L_{ω}(s) is defined as:

$$\begin{matrix}{T}_{ω} = \frac{{L}_{ω} ( s )}{1 + {L}_{ω} ( s )} , & {L}_{ω} ( s ) = \frac{{G}_{M}^{q} {K}_{2}^{q}}{1 + {G}_{M}^{q} {K}_{1}^{q}}\end{matrix} . \qquad ( 100 )$$

Moreover, let us assume that through an appropriate design of the controllers

$${K}_{1}^{q} and {K}_{2}^{q}$$

in (100), the open-loop transfer function L_{ω}(s) takes the following parametric form:

$${L}_{ω} ( s ) = \frac{{k}_{ω}}{s} ( \frac{s + {α}_{θ}}{s + {β}_{θ}} ) ( \frac{1}{s + {ω}_{f}} ) , \qquad ( 101 )$$

where k_{ω}, α_{θ}, β_{θ}, and ω_{f} are tunable parameters. These parameters set the open-loop gain crossover frequency ω_{gc}, phase margin φₚₘ, and low-frequency gain, thus determining the transient and steady-state response of T_{ω}.

Typically, achieving a desired transient response involves adjusting the phase margin φₚₘ and ω_{gc} for L_{ω}(s) through trial and error. This adjustment is based on the principle that φₚₘ is proportional to the overall damping of the system, whereas ω_{gc} is inversely proportional to the system's inertia.

A more systematic approach involves establishing approximate, yet insightful links between φₚₘ, ω_{gc}, and key transient performance metrics using a simplified surrogate second-order system. Specifically, we approximate T_{ω} and its open-loop transfer function L_{ω} using the following second-order system, with open-loop transfer function Lₛₒ:

$$\frac{{ω}_{n}^{2}}{{s}^{2} + 2 {ζω}_{n} s + {ω}_{n}^{2}} = \frac{{L}_{so} ( s )}{1 + {L}_{so} ( s )} , {L}_{so} ( s ) = \frac{{ω}_{n}^{2}}{s ( s + 2 {ζω}_{n} )} , \qquad ( 102 )$$

In some embodiments, the operations further comprise deriving parameters for the virtual inertia control from a surrogate second-order system model relating a phase margin to system damping and relating a gain crossover frequency to virtual inertia constant. This surrogate model can yield convenient closed-form solutions in terms of damping ratio ζ and natural frequency ωₙ for several key parameters:

1) Step-response characteristics: For an underdamped system with (<1, the peak time tₚ, and maximum overshoot Mₚ are given by

$${t}_{p} = \frac{π}{{ω}_{n} \sqrt{1 - {ζ}^{2}}} , {M}_{p} = exp ( - \frac{ζπ}{\sqrt{1 - {ζ}^{2}}} ) . \qquad ( 103 )$$

2) Swing equation representation: The second-order system also represents the following linearized swing equation for the dq-frame rotating angle θ:

$$\frac{2 H}{{ω}_{0}} \ddot{θ} + \frac{D}{{ω}_{0}} \dot{θ} = \frac{{v}_{0}^{2} cos {δ}_{0}}{{ZS}_{base}} ( {θ}_{g} - θ + {δ}_{0} ) , \qquad ( 104 )$$

where, ω₀ and v₀ are nominal voltage and frequency, S_{base} is base power, Z is the line impedance, and δ₀ is the load angle for nominal power P₀, defined as

$${δ}_{0} = {sin}^{- 1} ( {ZP}_{0} / {v}_{0}^{2} ) .$$

The inertia constant H and the damping D are given by

$$H = \frac{{v}_{0}^{2} {ω}_{0} cos {δ}_{0}}{2 {ω}_{n}^{2} {ZS}_{base}} , D = \frac{2 ζ {v}_{0}^{2} {ω}_{0} cos {δ}_{0}}{{ω}_{n} {ZS}_{base}} \qquad ( 105 )$$

3) Open-loop φₚₘ and ω_{gc}: For the open-loop transfer function Lₛₒ(s) in (80), the gain crossover frequency ω_{gc} and phase margin φₚₘ are

$${ω}_{gc} = {ω}_{n} \sqrt{\sqrt{1 + 4 {ζ}^{4}} - 2 {ζ}^{2}} , \qquad ( 106 )$$

$${ϕ}_{pm} = {tan}^{- 1} \frac{2 ζ}{\sqrt{\sqrt{1 + 4 {ζ}^{4}} - 2 {ζ}^{2}}} . \qquad ( 107 )$$

In the following proposition, we use these expressions to facilitate a direct linkage between phase margin, gain crossover frequency, and the system's transient characteristics (e.g., frequency nadir, inertia, and rate of change of frequency).

Proposition 7.2: (a) For L_{ω}(s) in (101), a good initial choice for the open-loop phase margin φₚₘ and the gain crossover frequency ω_{gc} can be determined by examining the following transient characteristics.

1) Frequency nadir: For a given grid frequency deviation Δω_{g}, the inverter experiences a frequency nadir

$${Δω}_{nadir} = ( 1 + {M}_{p} ) {Δω}_{g} \qquad ( 108 )$$

where the overshoot Mₚ is related to the phase margin φₚₘ through the damping ratio ζ as follows:

$$ζ = \frac{\vert ln {M}_{p} \vert}{\sqrt{{π}^{2} + {ln}^{2} {M}_{p}}} , {ϕ}_{pm} = {tan}^{- 1} \frac{2 ζ}{\sqrt{\sqrt{1 + 4 {ζ}^{4}} - 2 {ζ}^{2}}} . \qquad ( 109 )$$

This relationship determines the required phase margin based on the desired overshoot for underdamped system ζ<1.

2) Virtual inertia: To achieve the desired inertia constant H, the gain crossover frequency should be initialized as

$${ω}_{gc} \approx {v}_{0} \sqrt{\frac{{ω}_{0} cos {δ}_{0}}{2 {HZS}_{base}}} \sqrt{\sqrt{1 + 4 {ζ}^{4}} - 2 {ζ}^{2}} \qquad ( 110 )$$

where Z is the transmission line impedance, and ζ is determined from (87).

3) RoCoF: Given the damping ratio (gain crossover frequency ω_{gc}, overshoot Mₚ, and grid frequency deviation Δω_{g}, the RoCoF can be roughly calculated as:

$${RoCoF}_{{t}_{p}} ( {Δω}_{g} ) \approx \frac{{ω}_{gc} ( 1 + {M}_{p} ) \sqrt{1 - {ζ}^{2}}}{π \sqrt{\sqrt{1 + 4 {ζ}^{4}} - 2 {ζ}^{2}}} {Δω}_{g} rad / {s}^{2} \qquad ( 111 )$$

for the time window tₚ (peak time).

(b) The open-loop parameters k_{ω}, α_{θ}, β_{θ}, and ω_{f} in (101) are determined by solving the following set of equations:

$${ϕ}_{pm} = {tan}^{- 1} \frac{{ω}_{f}}{{ω}_{gc}} + {tan}^{- 1} \frac{{ω}_{gc}}{{α}_{θ}} - {tan}^{- 1} \frac{{ω}_{gc}}{{β}_{θ}} , \qquad ( 112 )$$

$${k}_{ω} = {ω}_{gc} \sqrt{( {ω}_{gc}^{2} + {ω}_{f}^{2} ) ( {ω}_{gc}^{2} + {β}_{θ}^{2} ) / ( {ω}_{gc}^{2} + {α}_{θ}^{2} )} , \qquad ( 113 )$$

$$\frac{{α}_{θ}}{{β}_{θ}} = \frac{{v}_{0} {ω}_{f} {G}_{M}^{q} ( j 0 )}{{k}_{ω}} ( \frac{1}{{κ}_{θ}} ) , max \{ {α}_{θ} , {β}_{θ} \} ≪ {ω}_{gc} . \qquad ( 114 )$$

Here, the phase margin φₚₘ and the gain crossover frequency ω_{gc} are calculated based on the transient requirements specified in part (a). The parameter κ_{θ} characterizes the steady-state operation and sets the ratio α_{θ}/β_{θ}.

We introduced a novel synchronization condition and outlined a loop-shaping method to design for the desired frequency transient response. However, we have not yet presented a specific design for the controllers

$${K}_{1}^{q} and {K}_{2}^{q}$$

that simultaneously satisfy the synchronization conditions in Proposition 7.1 and shape L_{ω} for inertia, RoCoF, and related transient requirements. The next section addresses these requirements in detail as part of the control design.

We have developed a comprehensive control design system for analyzing both stability and performance. In this section, we present an example controller design for K_{L},

$${K}^{d} , {K}_{1}^{d} and {K}_{2}^{q}$$

in FIG. 3, that meets the specified stability and performance requirements.

### A. Design of the Plant Shaping Controller K_{L}

As discussed in Sections III-C and IV, K_{L} mitigates the impact of MIMO coupling on closed-loop stability and performance. We proposed two designs for K_{L} in (22) and (32). The choice of K_{L} in (22) provides stronger stability margins and yields the following SISO plants for the d- and q-axes:

$${G}_{M}^{d} = \frac{1}{Z} ( \frac{{ω}_{m}}{s + {ω}_{m}} ) , {G}_{M}^{q} = \frac{1}{Z} ( \frac{{ω}_{m}}{s + {ω}_{m}} ) , \qquad ( 115 )$$

where Z denotes the line impedance. In contrast, the choice of K_{L} in (32) compromises the stability margin in exchange for improved active power tracking under complex line impedances. This choice of K_{L} yields the following SISO plants for the d- and q-axes:

$${G}_{M}^{d} = \frac{1}{Z} ( \frac{{ω}_{m}}{s + {ω}_{m}} ) , {G}_{M}^{q} = \frac{sin {ϕ}_{z}}{Z} ( \frac{{ω}_{m}}{s + {ω}_{m}} ) , \qquad ( 116 )$$

where φ_{z} denotes the line impedance angle.

Once the appropriate K_{L} is selected, the control design is simplified to two independent SISO problems for the d- and q-axes. For each axis, the corresponding SISO plants

$${G}_{M}^{d} and {G}_{M}^{q}$$

follow from (115) or (116) depending on the choice of K_{L}.
B. Design of the d-Axis Controller K^{d}

In the d-axis,

$${K}^{d} {G}_{M}^{d}$$

represents the open-loop transfer function for both the sensitivity S^{d} in (49), and the complementary sensitivity T^{d} in (117).

$$\tilde{T} = [ \begin{matrix}{T}^{d} & 0 \\ 0 & {T}^{q}\end{matrix} ] [ \begin{matrix}{( 1 + {K}^{q} {G}_{M}^{d} )}^{- 1} & 0 \\ 0 & {S}^{q} {K}^{q} {G}_{M}^{q}\end{matrix} ] \qquad ( 117 )$$

Therefore, K^{d} can be designed using classical loop-shaping techniques. In this work, we adopt the following structure for K^{d}:

$${K}^{d} = ( \frac{s + {α}_{v}}{s + {β}_{v}} ) {\underbrace{( \frac{{K}_{PR}}{{G}_{m}^{d}} ) ( \frac{{k}_{d}}{( s + {ω}_{1} ) {( s + {ω}_{2} )}^{2}} )}}_{{K}_{rem}^{d} ( s )} , \qquad ( 118 )$$

and outline a procedure for tuning the controller parameters.

1) PR compensator: As outlined previously, the set of PR compensators K_{PR} from (44) is included to improve stability, suppress THD, and enable fault ride-through.

2) Bandwidth and stability: Robust stability is ensured if the open-loop transfer function

$${K}^{d} {G}_{M}^{d}$$

maintains a phrase margin φₚₘ>50° at the gain crossover frequency ω_{d}. By selecting the gain crossover frequency ω_{d} sufficiently higher than max{αᵥ, βᵥ}, the desired phase margin is achieved if the parameters k_{d}, ω₁, and ω₂ satisfy:

$${ϕ}_{pm} - ∠ {K}_{PR} ( j {ω}_{d} ) - 2 {tan}^{- 1} \frac{{ω}_{2}}{{ω}_{d}} + {tan}^{- 1} \frac{{ω}_{d}}{{ω}_{1}} = 0 \qquad ( 119 )$$

$${k}_{d} - {‖ {K}_{PR} ( j {ω}_{d} ) ‖}_{2} \sqrt{( {ω}_{1}^{2} + {ω}_{d}^{2} ) ( {ω}_{2}^{2} + {ω}_{d}^{2} )} = 0 \qquad ( 120 )$$

Since these equations involve three unknown parameters, obtaining a unique solution requires fixing one parameter, typically ω₁. A practical rule is to choose ω₁ below the crossover frequency ω_{d}, but slightly above the highest resonant frequency of K_{PR}.

$$\frac{{α}_{v}}{{β}_{v}} = \frac{{G}_{M}^{d} ( j 0 ) / {κ}_{v} - 1}{{G}_{M}^{d} ( j 0 ) / {K}_{rem}^{d} ( j 0 )} , \qquad ( 121 )$$

$$\frac{{α}_{θ}}{{β}_{θ}} = \frac{1 / {κ}_{θ}}{{v}_{0} {K}_{rem}^{q} ( j 0 )}$$

3) Steady-state operation mode: The steady-state operating mode is uniquely determined by the pair (κᵥ, κ_{θ}). To achieve the desired κᵥ, the controller parameters αᵥ and βᵥ are obtained by substituting

$${K}_{rem}^{d} ( s )$$

from (118) into (121):

$$\frac{{α}_{v}}{{β}_{v}} = \frac{{ω}_{1} {ω}_{2}^{2}}{{k}_{d}} ( \frac{1 / {κ}_{v}}{Z} - 1 ) , max \{ {α}_{v} , {β}_{v} \} << {ω}_{d} . \qquad ( 122 )$$

Here, the parameters k_{d}, ω₁, and ω₂ have already been determined by the phase margin requirement.

$$[ \begin{matrix}{i}_{g}^{′ d} \\ {i}_{g}^{′ q}\end{matrix} ] = [ \begin{matrix}{i}_{0}^{′ d} \\ {i}_{0}^{′ q}\end{matrix} ] - [ \begin{matrix}{κ}_{v} & 0 \\ 0 & {κ}_{θ}\end{matrix} ] [ \begin{matrix}Δ {v}_{g} \\ Δ {ω}_{g}\end{matrix} ] . \qquad ( 123 )$$

According to (123), 1/κᵥ also represents the voltage droop coefficient. To avoid negative values for αᵥ or βᵥ, we must have 1/κᵥ≥Z, implying that the voltage droop coefficient is bounded below by the line impedance.
C. Design for the q-Axis Controllers

$${K}_{1}^{q} and {K}_{2}^{q}$$

The q-axis controller, K^{q}, comprises two parallel controllers,

$${K}_{1}^{q} and {K}_{2}^{q} ,$$

as shown in FIG. 3. Consequently, achieving stability and control objectives for the q-axis requires the concurrent design of both

$${K}_{1}^{q} and {K}_{2}^{q} .$$

Specifically, a successful design must address three key challenges:

1)

$${K}^{q} = {K}_{1}^{q} + {K}_{2}^{q}$$

and results in a stable sensitivity transfer function S^{q}, as defined in (21). Moreover, S^{q} must provide sufficient attenuation of exogenous inputs to enhance current tracking performance, as discussed in Section V.

2)

$${K}_{1}^{q} and {K}_{2}^{q}$$

shape the open-loop transfer function L_{ω}(s), as defined in (100), into the specific form presented in (101) to achieve the desired inertia and RoCoF response.

3)

$${K}_{1}^{q} and {K}_{2}^{q}$$

meet the synchronization condition outlined in Proposition 7.1.

Designing a two-degree-of-freedom (2-DOF) controller that meets all the aforementioned objectives can be quite challenging. However, by introducing suitable auxiliary variables, the 2-DOF design problem can be transformed into a simpler 1-DOF control design. In this case, we define the following sensitivity transfer functions as auxiliary variables:

$${S}_{ω} = \frac{1}{1 + {L}_{ω} ( s )} , {S}_{θ} = \frac{1}{1 + {G}_{M}^{q} {K}_{1}^{q}} . \qquad ( 124 )$$

Using the definitions of L_{ω} in (100) and S_{θ} in (124), we can express

$${K}_{1}^{q} and {K}_{2}^{q}$$

in terms of L_{ω} and S_{θ} as follows:

$${K}_{1}^{q} = \frac{1 - {S}_{θ}}{{G}_{M}^{q} {S}_{θ}} , {K}_{2}^{q} = \frac{{L}_{ω}}{{G}_{M}^{q} {S}_{θ}} . \qquad ( 125 )$$

An important feature of this formulation is that, for a given transient requirement (e.g. inertia, nadir, and RoCoF), L_{ω}(s) in (125) is entirely determined by Proposition 7.2.

As a result, the control design is reduced to a single degree-of-freedom, which involves shaping S_{θ} to satisfy the q-axis control objectives. Once S_{θ} is determined, both

$${K}_{1}^{q} and {K}_{2}^{q}$$

are fully specified by (125). In what follows, we express these objectives in terms of S_{θ} and present the corresponding design criteria.

1) Synchronization: The synchronization condition in Proposition 7.1 can be reformulated in terms of S_{θ} by expressing the ratio of two controllers in (100) as:

$$\frac{{K}_{1}^{q}}{{K}_{2}^{q}} = \frac{1 - {S}_{θ}}{{L}_{ω}} \qquad ( 126 )$$

According to (101), 1/L_{ω} has a zero at the origin. Therefore, to satisfy the condition in Proposition 7.1, it is necessary and sufficient that 1−S_{θ}(j0)=0, i.e., S_{θ}(j0)=1.

Furthermore, since

$${G}_{M}^{q}$$

is strictly proper and

$${K}_{1}^{q}$$

is a proper transfer function, it follows from the definition of S_{θ} in (122) that S_{θ}(s)→1 as s→∞. As a result, S_{θ} must satisfy the following limiting conditions:

$${lim}_{s \to 0} {S}_{θ} ( s ) = {lim}_{s \to ∞} {S}_{θ} ( s ) = 1 \qquad ( 127 )$$

This ensures that S_{θ} complies with the synchronization condition while remaining consistent with the underlying closed-loop dynamics.

2) Robust stability: The q-axis plant model,

$${G}_{M}^{q} ,$$

is subject to perturbations arising from unmodeled dynamics, neglected nonlinearities, and parameter variations, particularly under weak grid conditions. These perturbations can adversely impact two key q-axis transfer functions: T^{q} in (117) which is the closed-loop transfer function between the current setpoint

$${i}_{0}^{′ q}$$

and the grid current

$${i}_{g}^{g}$$

(see (15)), and T_{ω}(78) which characterizes the transient frequency response of the inverter.

The relative sensitivity of the transfer functions T_{ω}(s) and T^{q}(s) to perturbations in the plant model

$${G}_{M}^{q}$$

can be mathematically quantified using their normalized derivatives with respect to

$${G}_{M}^{q} :$$

$$\frac{{G}_{M}^{q}}{{T}_{ω}} ( \frac{d {T}_{ω}}{d {G}_{M}^{q}} ) = {S}_{ω} {S}_{θ} , \frac{{G}_{M}^{q}}{{T}^{q}} ( \frac{d {T}^{q}}{d {G}_{M}^{q}} ) = {S}_{ω} {S}_{θ} , \qquad ( 128 )$$

where S_{ω} and S_{θ} are the same as (124). The product S_{ω}S_{θ} in (103) serves as a unique measure of the robustness to model perturbations. Specifically, if

$${‖ {S}_{ω} ( j ω ) {S}_{θ} ( j ω ) ‖}_{2} < 1 , ∀ ω ∈ [ {ω}_{1} , {ω}_{2} ] , \qquad ( 129 )$$

then, within the frequency range [ω₁, ω₂], the relative deviations of T_{ω}(s) and T^{q}(s) from their nominal transfer functions remain small, even under variations in

$${G}_{M}^{q} .$$

Consequently, T_{ω}(s) and T^{q}(s) preserve their stability and performance characteristics even under plant perturbations. This is particularly important in weak grid operation, where impedance variations are common.

3) Disturbance rejection: In addition to its robustness implications, the product S_{ω}S_{θ} also directly influences closed-loop performance. In embodiments, the q-axis sensitivity S^{q} can be expressed as:

$${S}^{q} = \frac{1}{1 + {G}_{M}^{q} ( {K}_{1}^{q} + {K}_{2}^{q} )} = \frac{1 / ( 1 + {G}_{M}^{q} {K}_{1}^{q} )}{1 + {L}_{ω} ( s )} = {S}_{ω} {S}_{θ} . \qquad ( 130 )$$

Substituting S^{q}=S_{ω}S_{θ} yields the following upper bound on the q-axis current tracking error:

$${‖ {e}^{′ q} ( ω ) ‖}_{2} \leq {‖ {S}_{ω} ( j ω ) {S}_{θ} ( j ω ) ‖}_{2} {‖ {i}_{0}^{′ q} ( ω ) + {G}_{M}^{q} {d}^{q} ( ω ) ‖}_{2} . \qquad ( 131 )$$

The upper bound reveals that the robustness condition in (129) also serves as a direct measure of disturbance attenuation. In other words, smaller values of |S_{ω}(jω)S_{θ}(jω)∥₂ result in better suppression of the impact of exogenous inputs on the current tracking error, thereby enhancing q-axis current regulation.

4) Inertial design: Choosing a large inertia constant H to achieve pronounced virtual inertia places constraints on the q-axis control design. Specifically, as the inertia constant H increases, the gain crossover frequency ω_{gc} of L_{ω}(s) defined in (110) decreases (see FIG. 18).

Consequently, the ability of S_{ω} to contribute to robustness and disturbance rejection, as described in (127), is reduced at frequencies higher than ω_{gc}. More precisely, based on the definition of S_{ω} in (100), and as shown in FIG. 18, for frequencies above ω_{gc}, we have:

$${S}_{ω} ( j ω ) \approx 1 ⇒ ‖ {S}_{ω} ( j ω ) {S}_{θ} ( j ω ) {‖}_{2} \approx {‖ {S}_{θ} ( j ω ) ‖}_{2} \qquad ( 132 )$$

This indicates that for ω>ω_{gc}, the magnitude of the product S_{ω}S_{θ}=S^{q} is primarily governed by S_{θ} as shown in FIG. 18. Therefore, to satisfy the robustness criterion in (129) and improve disturbance rejection above this frequency range, it is crucial that ∥S_{θ}(jω)∥₂ remains small for w>ω_{gc}.

Remark 9: The key takeaway from the preceding analysis is that achieving robust stability and effective disturbance rejection, particularly in high-inertia designs, requires ∥S_{θ}∥₂ to remain small within a specific frequency band. This band starts well below the gain crossover frequency ω_{gc} of L_{ω}(s) (defined in (110)) and extends up to the desired q-axis bandwidth ω_{q}, above ω_{gc}. Furthermore, S_{θ} must approach unity at both DC and high frequencies to satisfy the synchronization and consistency condition in (127). Consequently, the transfer function of S_{θ} exhibits the characteristics of a unity-gain bandstop filter as shown in FIG. 18.

Proposition 8.1: The characteristics of S_{θ} highlighted in Remark 9 lead to three key design criteria for

$${K}_{1}^{q} :$$

1) Synchronization: To ensure that S_{θ} satisfies the synchronization condition in (102), the controller

$${K}_{1}^{q}$$

must be a proper transfer function that includes a zero at the origin.

2) Robustness and disturbance rejection: To minimize ∥S_{θ}∥₂ within the frequency range [ω_{L}, ω_{q}], and thereby improve robustness and disturbance rejection (see (129)), the corresponding open-loop transfer function

$${L}_{θ} = {G}_{M}^{q} {K}_{1}^{q}$$

should be shaped as a passband filter. In particular, L_{θ} should exhibit gain crossover at frequencies ω_{L}, and ω_{q} (i.e., ∥L_{θ}(jω_{L})∥₂=∥L_{θ}(jω_{q})∥₂=1, and achieve midband gain A_{F}>1, as shown in FIG. 18.

To promote robust stability margins, the frequency range [ω_{L}, ω_{q}] should begin well below ω_{gc} in (110), and extend beyond it to the desired q-axis bandwidth ω_{g}.

3 Stability: To ensure robust stability of S_{θ}, the open-loop

$${L}_{θ} = {G}_{M}^{q} {K}_{1}^{q}$$

should maintain a phase margin φₚₘ of at least 50° at the upper crossover frequency ω_{q}.

To satisfy the conditions outlined in Proposition 8.1, we present the following sample design for

$${K}_{1}^{q} :$$

$${K}_{1}^{q} = ( \frac{{K}_{PR}}{{G}_{M}^{q}} ) ( \frac{s}{s + {ω}_{1}} ) ( \frac{{k}_{q}}{( s + {ω}_{2} ) {( s + {ω}_{3} )}^{2}} ) , \qquad ( 133 )$$

This controller is strictly proper and includes a zero at the origin. Therefore, the design task simplifies to selecting the parameters ω₁, ω₂, ω₃ and k_{q} such that

$${L}_{θ} = {G}_{M}^{q} {K}_{1}^{q}$$

forms a bandpass profile, with gain crossover at frequencies ω_{L} and ω_{q} and a midband gain A_{F}>1, as shown in FIG. 18.

For desired q-axis bandwidth ω_{q}, midband gain A_{F}, and phase margin φₚₘ, the parameters ω₂ and ω₃ are determined by solving the following system of equations:

$${ϕ}_{pm} - 2 {tan}^{- 1} ( {ω}_{3} / {ω}_{q} ) + {tan}^{- 1} ( {ω}_{q} / {ω}_{2} ) = 0 , \qquad ( 134 )$$

$${A}_{F} - ( 1 + {( {ω}_{q} / {ω}_{3} )}^{2} ) \sqrt{1 + {( {ω}_{q} / {ω}_{2} )}^{2}} = 0. \qquad ( 135 )$$

After ω₂ and ω₃ are computed, k_{q} and ω₁ are obtained as:

$${k}_{q} = {A}_{F} {ω}_{2} {ω}_{3}^{2} , {ω}_{1} = {ω}_{L} \sqrt{{A}_{F}^{2} - 1} . \qquad ( 136 )$$

If φ₁>ω₂, then ω_{L} must be decreased to ensure ω₁<ω₂.

Once the controller

$${K}_{1}^{q}$$

has been fully designed, its parallel counterpart

$${K}_{2}^{q}$$

is directly given by:

$${K}_{2}^{q} = ( \frac{s + {α}_{θ}}{s ( s + {β}_{θ} )} ) ( \frac{{k}_{ω}}{{G}_{M}^{q}} ) ( \frac{1 + {G}_{M}^{q} {K}_{1}^{q}}{s + {ω}_{f}} ) , \qquad ( 137 )$$

where all parameters are specified according to Proposition 7.2 to achieve the desired frequency transient response.

In some embodiments, a method for designing q-axis controllers for inverter synchronization and frequency response includes specifying desired inertia constant and rate of change of frequency limits and determining open-loop transfer function parameters from transient requirements. The method can further include decomposing two-degree-of-freedom control into auxiliary sensitivity functions and shaping sensitivity functions to satisfy synchronization, robustness, and disturbance rejection criteria. The method can conclude with implementing controllers through cascaded control structure with appropriate compensators.

Remark 10: Increasing the midband gain A_{F} improves disturbance rejection and robust stability, but at the cost of voltage quality. This trade-off can be quantified by the transfer function between the q-axis disturbance d^{q} and

$${v}_{c}^{q} :$$

$${\hat{v}}_{c}^{q} = {S}_{ω} ( 1 - {S}_{θ} ) {\hat{d}}^{q} {⇒}^{ω ∈ [ {ω}_{gc} , {ω}_{q} ]} {\hat{v}}_{c}^{q} \approx \frac{{A}_{F}}{1 + {A}_{F}} {\hat{d}}^{q} . \qquad ( 138 )$$

As A_{F} increases, the disturbance-to-voltage path approaches unity within the band [ω_{gc}, ω_{q}], compromising voltage quality despite improved robustness.

In the following section, we will provide details on implementing these controllers using inverter closed-loop dynamics and discuss practical deployment on an embedded device.

### DSP Implementation

The closed-loop block diagram in FIG. 3 is helpful for control design and analysis but does not represent the embedded implementation of the feedback controller. This section provides a brief overview of control implementation on a real-time embedded device.

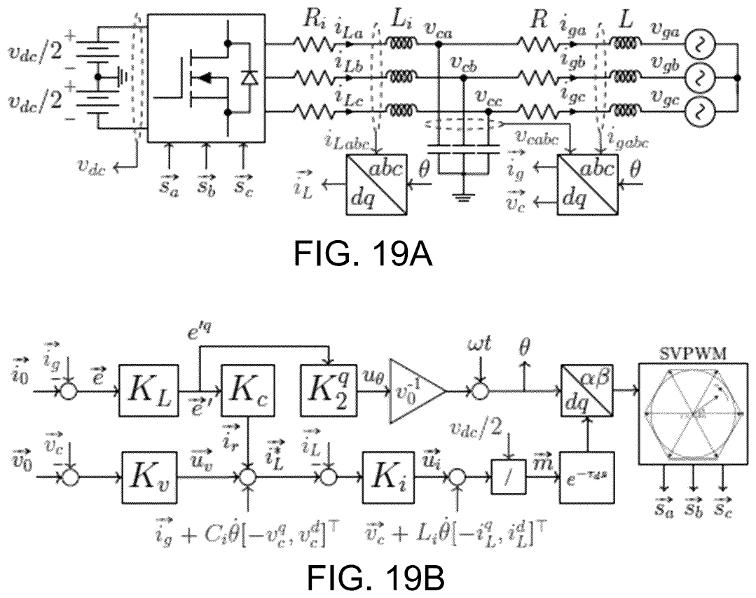

FIG. 19A shows a typical three-phase DC/AC inverter connected to the grid via an LCL filter. Vector switching signals {\vec{sₐ}, \vec{s_{b}}, \vec{s_{c}}} contain the gating signals for the switches in each of the three-phase legs. These switching signals are generated by the DSP and serve as the only control input from the DSP to the physical hardware. On the sensing side, three measurements are taken from the inverter: the DC input port voltage v_{dc}, the filter inductor current i_{Labc}, capacitor voltage v_{cabc}, and the grid-side current i_{gabc}. These per-phase measurements in the abc frame are transformed into their dq frame equivalents, \vec{i_{L}}, \vec{v_{c}}, and \vec{i_{g}}, using the abc to dq (Park) transform, which utilizes the angle θ generated by the control algorithm.

FIG. 19B shows the embedded implementation of the controllers and the corresponding signal flow. Note that K_{L} and

$${K}_{2}^{q}$$

are directly implemented, while K^{d} and

$${K}_{1}^{q}$$

are implemented indirectly via K_{c}, Kᵥ and Kᵢ. As shown in FIG. 19B, the switching signals {\vec{sₐ}, \vec{s_{b}}, \vec{s_{c}}} are generated by first applying the dq to αβ transform to the modulation signal \vec{m} and subsequently generating the abc switching signals using SVPWM method.

It is important to note that the original feedback controller, as shown in FIG. 5 does not directly include the modulation signal \vec{m} or the dq frame angle θ required for the Park and inverse Park transform. This is because these signals were embedded in the control signals \vec{uᵢ}, and u_{θ} to simplify control design and analysis. However, FIG. 19B explicitly shows how the modulation signal m′θ is recovered from the control signal \vec{uᵢ} based on (139).

$$\vec{\hat{m}} = \frac{2}{{v}_{dc}} ( \vec{{\hat{u}}_{i}} + \vec{{\hat{v}}_{c}} + ℒ \{ {L}_{s} {\dot{θ} [ - {i}_{L}^{q} , {i}_{L}^{d} ]}^{T} \} ) , \qquad ( 139 )$$

Furthermore, according to Proposition 3.1, the control signal u_{θ} from

$${K}_{2}^{q}$$

encodes the dq rotating angle θ. Therefore, in practice, u_{θ} is implemented indirectly through θ as follows

$$θ ( t ) = {ω}_{0} t + \frac{1}{{v}_{0}} {u}_{θ} ( t ) ( mod ) ( 2 π ) . \qquad ( 140 )$$

### X. Employing Seamless Transition to Achieve Current Limiting Operation in GFM Inverters

Synchronous generators can tolerate overcurrent up to five times their rated value for short periods. Furthermore, standards such as IEC 60034-1 require that AC generators with rated output below 1200 MVA must withstand currents equal to 1.5 times their rated current for at least 30 seconds. In contrast, switched devices such as IGBTs, MOSFETs, and GaNs can only endure short overcurrent spikes of only 1.5 to 2 times their rated current for very brief periods, typically in the range of milliseconds.

This limited overcurrent capability is particularly challenging in GFM operation, where we lack the high bandwidth and precise control over the output current that GFL inverters provide. As a result, GFM inverters are more susceptible to sudden overcurrent transients caused by fluctuations in grid voltage and frequency. This limitation makes it difficult to create a robust, GFM-powered grid that can effectively withstand overcurrent conditions.

The seamless transition system offers an effective solution for the GFM current-limiting operation by gradually shifting the inverter's operation toward the GFL mode as the inverter's output current approaches the predefined current limit. This shift to GFL operation enables more accurate control over the output current near the current limit, allowing for a reliable current-limiting operation.

We implement the GFM-to-GFL transition by scaling the inverter's operation mode parameters (κᵥ, κ_{θ}) using a log-barrier function that depends on the ratio of the inverter's output current to maximum allowable current, ∥\vec{i}′∥/iₘₐₓ as shown below:

$$[ \begin{matrix}{κ}_{v} & 0 \\ 0 & {κ}_{θ}\end{matrix} ] ( \vec{{ι}^{′}} ) = [ \begin{matrix}{κ}_{v}^{*} & 0 \\ 0 & {κ}_{θ}^{*}\end{matrix} ] / ( 1 - log ( 1 - ‖ \vec{{i}^{′}} ‖ / {i}_{max} ) / {α}_{t} ) \qquad ( 141 )$$

Here,

$$( {κ}_{v}^{*} , {κ}_{θ}^{*} )$$

are constants representing the inverter's nominal operating mode when the output current remains within safe limits. The parameter iₘₐₓ sets the desired current limit, while αₜ adjusts the sharpness of the mode transition. As the inverter's output current magnitude ∥\vec{i}′∥/iₘₐₓ approaches imax, the log-barrier function in (137) tends toward infinity, scaling (κᵥ, κ_{θ}) from the initial value of

$$( {κ}_{v}^{*} , {κ}_{θ}^{*} )$$

down to zero. This pushes the inverter's operation point towards (0, 0), indicating a transition towards GFL mode, as illustrated in FIG. 9.

We conclude our analysis by examining how the current-limiting law in (137) shapes the current response of the GFM inverter to grid voltage and frequency deviations. By substituting (140) into (123), we obtain the 3D surface shown in FIG. 12a, which illustrates how the magnitude of the inverter's output current varies with changes in grid voltage and Δv, frequency Δω.

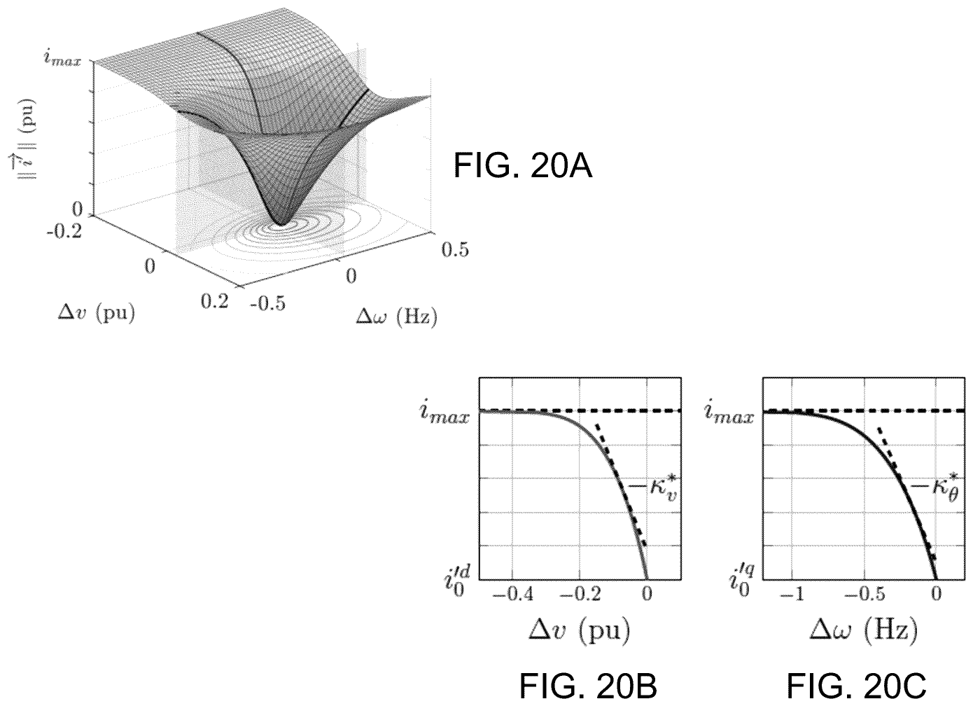

As shown in FIG. 20A, the GFM inverter preserves its typical droop characteristics when grid voltage and frequency deviations are small. However, with larger deviations, the output current reaches the maximum limit iₘₐₓ instead of increasing indefinitely. This behavior is further illustrated by examining two specific cross-sections of the 3D surface: one with the i′^{d}=0 plane (blue) and the other with i′^{q}=0 (magenta). As shown in FIG. 20B and FIG. 20C, these cross sections reveal that κᵥ and κ_{θ} define the inverse droop slope for small deviations, while for larger deviations, the slope approaches zero, capping the output current at iₘₐₓ. The current limiting mechanism works like an automatic transmission that shifts gears as load increases. As output current approaches the safety limit, the log-barrier function smoothly transitions the inverter from grid-forming (voltage source) behavior toward grid-following (current source) behavior. This provides the precise current control needed to prevent overcurrent damage while maintaining continuous operation.

In some embodiments, the operations further comprise implementing current limiting operation by dynamically adjusting operating mode parameters using a barrier function based on a ratio of output current to a maximum allowable current. In embodiments, wherein the barrier function causes transition toward a grid-following mode as grid current approaches the maximum allowable current. In embodiments, the barrier function includes a logarithmic barrier that scales operating mode parameters inversely with proximity to the maximum allowable current.

Remark 12: Implementing a log-function directly in DSP consumes unnecessary computational resources, with minimal benefit compared to using a lookup table. Therefore, we recommend tabulating the scaling factor in (141) for a finite set of values of ∥\vec{i}′∥/iₘₐₓ within the interval (0, 1], and then interpolating these values instead of recalculating the logarithm each time.

FIG. 21 illustrates a block diagram illustrating an exemplary computer device 2100 (or computing device or computing system), in accordance with implementations of the present disclosure. Computer device 2100 can, for example, implement the distributed grid control system, as described above, to include the inverter controller 130 (FIG. 1). Example computer device 2100 can be connected to other computer devices in a LAN, an intranet, an extranet, and/or the Internet. Computer device 2100 can operate in the capacity of a server in a client-server network environment. Computer device 2100 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 2100 can include a processing device 2102 (also referred to as a processor, central processing unit (CPU), or graphics processing unit (GPU)), a volatile memory 2104 (or main memory, e.g., read-only memory (ROM), flash memory, dynamic random access memory (DRAM) such as synchronous DRAM (SDRAM), etc.), a non-volatile memory 2106 (e.g., flash memory, static random access memory (SRAM), etc.), and a secondary memory (e.g., a data storage device 2116), which can communicate with each other via a bus 2130.

Processing device 2102 (which can include processing logic 2122) represents one or more general-purpose processing devices such as a microprocessor, central processing unit, or the like. More particularly, processing device 2102 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 2102 can also be one or more special-purpose processing devices such as an ASIC, a FPGA, a digital signal processor (DSP), network processor, or the like. In accordance with one or more aspects of the present disclosure, processing device 2102 can be configured to execute instructions performing the method disclosed herein.

Example computer device 2100 can further comprise a network interface device 2108, which can be communicatively coupled to a network 2120. Example computer device 2100 can further comprise a video display 2110 (e.g., a liquid crystal display (LCD), a touch screen, or a cathode ray tube (CRT)), an alphanumeric input device 2112 (e.g., a keyboard), a cursor control device 2114 (e.g., a mouse), and an acoustic signal generation device 2118 (e.g., a speaker).

Data storage device 2116 can include a computer-readable storage medium (or, more specifically, a non-transitory computer-readable storage medium) 2124 on which is stored one or more sets of executable instructions 2126. In accordance with one or more aspects of the present disclosure, executable instructions 2126 can comprise executable instructions performing the method disclosed herein.

Executable instructions 2126 can also reside, completely or at least partially, within volatile memory 2104 and/or within processing device 2102 during execution thereof by example computer device 2100, volatile memory 2104 and processing device 2102 also constituting computer-readable storage media. Executable instructions 2126 can further be transmitted or received over a network via network interface device 2108.

While the computer-readable storage medium 2124 is shown in FIG. 21 as a single medium, the term “computer-readable storage medium” or “non-transitory computer-readable storage medium storing instructions” or “computer-readable instructions” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMS, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A computing system for functional integration with a distributed power grid comprising one or more inverters, wherein the computing system comprises:
one or more processing devices; and
memory communicatively coupled with and readable by the one or more processing devices and having stored therein processor-readable instructions which, when executed by the one or more processing devices, cause the one or more processing devices to perform operations comprising:
controlling operation of an inverter, of the one or more inverters, by executing a feedback controller with a grid-tied line, of the distributed power grid, treated as a plant and comprising a unified algebraic control system operating based on a pair of closed-loop variables carried in closed-loop signals of the unified algebraic control system; and
controlling, using the feedback controller, transitions of the inverter between a plurality of operating modes by adjusting a magnitude of the closed-loop signals, which correspond to the pair of closed-loop variables, towards a setpoint of a plurality of setpoints, wherein each setpoint corresponds to a different operating mode of the plurality of operating modes.

2. The computing system of claim 1, wherein the plurality of operating modes comprises at least two or more of grid-forming (GFM), grid-following (GFL), static synchronous compensator (STATCOM), energy storage system (ESS), or voltage source inverter (VSI).

3. The computing system of claim 1, wherein the controlling the transitions further comprises adjusting the pair of closed-loop variables along trajectories in a control parameter space, starting and ending at setpoints, of the plurality of setpoints, corresponding respectively to an initial mode and a final mode of the plurality of operating modes.

4. The computing system of claim 1, wherein the pair of closed-loop variables comprise an inverter variable and a grid state variable, which are implemented as a control input and a disturbance using a direct quadrature formulation.

5. The computing system of claim 1, wherein controlling the transitions further comprises:
modeling, using direct quadrature formulation, inputs and outputs of the unified algebraic control system using a pair of a single input, single output (SISO) models comprising sensitivity and a multiplicative perturbation; and
deriving a coupling between the pair of SISO models.

6. The computing system of claim 5, wherein the operations further comprise:
factoring a set of primary closed-loop models and a corresponding closed-loop sensitivity model into a set of diagonal parts;
determining a bounded coupling perturbation between the set of diagonal parts; and
shaping sensitivity of the set of diagonal parts to minimize the bounded coupling perturbation.

7. The computing system of claim 1, wherein the operations further comprise:
quantifying sensitivities of a pair of two q-axis transfer functions of the unified algebraic control system, wherein the pair of two q-axis transfer functions comprises: i) a closed-loop transfer function between a current setpoint and a grid current; and ii) a transient frequency response of the inverter;
generating a measure of robustness to model perturbations as a product of the sensitivities; and
bounding a frequency range of operation of the inverter according to bounds of the measure of robustness to preserve stability and performance characteristics under plant perturbations.

8. The computing system of claim 1, wherein the operations further comprise:
implementing, as part of the unified algebraic control system, a cascaded closed-loop structure with an inner current loop and an outer voltage loop;
using feedback linearization to decouple inductor dynamics of an inductor and a capacitor being modeled within the inner current loop; and
employing a phase interpolator controller to shape the inner current loop into a unity gain low-pass filter.

9. The computing system of claim 1, wherein the feedback controller comprises a multiple input, multiple output (MIMO) feedback controller decomposed into:
a MIMO plant shaping controller component configured to transform line dynamics into a modified plant with reduced coupling and cross-channel interaction between a d-axis for voltage and a q-axis for frequency; and
a diagonal controller component configured to maintain stability and achieve target objectives associated with a decoupled d-axis and a decoupled q-axis under an impact of the modified plant.

10. The computing system of claim 9, wherein the plant shaping controller component is configured to achieve at least one of:
diagonal modified plant dynamics at steady state;
triangular modified plant dynamics at steady state; or
an optimal condition number for the modified plant across frequency ranges for a highest stability margin.

11. The computing system of claim 1, wherein the operations further comprise implementing mode-independent synchronization by maintaining synchronization conditions across the plurality of operating modes by:
ensuring capacitor voltage alignment with a direct-quadrature (dq) reference frame; and
achieving a frequency lock between the inverter and a grid frequency.

12. The computing system of claim 11, wherein the synchronization is achieved by configuring:
a first q-axis controller with at least two zeros at the origin relative to a second q-axis controller; and
the second q-axis controller with at least one pole at the origin.

13. The computing system of claim 1, wherein the operations further comprise characterizing the plurality of operating modes based on a number of zeros at the origin in sensitivity transfer functions, wherein characterizing comprises at least two of:
a grid-following mode corresponds to one zero in a d-axis, associated with grid voltage, and two zeros in a q-axis associated with grid frequency;
a grid-forming mode corresponds to no zeros in the d-axis and one zero in the q-axis;
a static synchronous compensator (STATCOM) mode corresponds to no zeros in the d-axis and two zeros in the q-axis; or
an energy storage system (ESS) mode corresponds to one zero in the d-axis and one zero in the q-axis.

14. The computing system of claim 1, wherein the operations further comprise implementing virtual inertia control by shaping a frequency response transfer function as a low-pass filter with adjustable bandwidth and damping characteristics to control:
a rate of change of frequency between the inverter and the grid-tied line; and
frequency nadir following disturbances bypassing a reliance on mimicking synchronous generator dynamics.

15. The computing system of claim 14, wherein the operations further comprise deriving parameters for the virtual inertia control from a surrogate second-order system model relating:
a phase margin to system damping; and
a gain crossover frequency to virtual inertia constant.

16. The computing system of claim 1, wherein the operations further comprise implementing droop characteristics for power sharing among parallel inverters, of the one or more inverters, wherein:
d-axis droop coefficients determine voltage regulation characteristics, wherein the d-axis droop coefficients are bounded by line impedance characteristics for d-axis voltage droop; and
q-axis droop coefficients, associated with grid frequency, determine frequency regulation characteristics, wherein the q-axis droop coefficients are bounded by a targeted frequency response bandwidth for q-axis frequency droop.

17. The computing system of claim 1, wherein the operations further comprise implementing current limiting operation by dynamically adjusting operating mode parameters using a barrier function based on a ratio of output current to a maximum allowable current, wherein the barrier function causes transition toward a grid-following mode as grid current approaches the maximum allowable current.

18. The computing system of claim 17, wherein the barrier function comprises a logarithmic barrier that scales operating mode parameters inversely with proximity to the maximum allowable current.

19. The computing system of claim 1, wherein the operations further comprise compensating for line-to-ground fault conditions by incorporating proportional-resonant compensators tuned to second harmonic frequency to maintain current control during fault conditions.

20. A method for controlling distributed inverters in a multi-source power grid, the method comprising:
executing, by a computing system operatively coupled to the distributed inverters, a unified algebraic control system in which different operating modes of the distributed inverters are defined by magnitudes of closed-loop signals, wherein the different operating modes cause differing control of the distributed inverters, and the closed-loop signals are associated with a plurality of control parameters;
parameterizing, within the unified algebraic control system, an operational space of the multi-source power grid as a two-dimensional continuum of the different operating modes using the plurality of control parameters;
enabling smooth transitions between the operating modes by adjusting the plurality of control parameters along trajectories in the operational space between setpoints of the plurality of control parameters; and
maintaining, by the computing system, stability during inverter transitions through pointwise stability at each operating mode, of the operating modes, and a controlled rate of parameter change associated with the plurality of control parameters.

21. The method of claim 20, further comprising:
factoring multiple input, multiple output (MIMO) sensitivity into:
diagonal two-single input, single output (2-SISO) sensitivity components; and
multiplicative coupled perturbation terms;
wherein the factorization enables conversion of MIMO analysis into simpler SISO problems than the MIMO analysis.

22. The method of claim 20, further comprising implementing a plant shaping controller that satisfies:
decoupling conditions at steady state through triangular or diagonal structure;
stability margin optimization at high frequencies; and
condition number optimization for robustness to input uncertainty.

23. The method of claim 20, further comprising designing, within the unified algebraic control system, a d-axis controller and a q-axis controller with specified characteristics comprising at least one of:
the d-axis controller determines voltage regulation and reactive power support;
the q-axis controller comprises parallel branches for frequency response and synchronization; or
the plurality of control parameters are selected to achieve a target bandwidth, a target phase margin, and a target steady-state droop.

24. The method of claim 20, further comprising implementing a seamless transition between grid-connected and islanded operation without implementing control reconfiguration, islanding detection schemes, or communication-based coordination.

25. A non-transitory computer-readable storage medium storing instructions that, when executed by one or more processors, cause the one or more processors to perform operations for inverter control, the operations comprising:
executing a feedback control algorithm that treats power grid connection of one or more inverters, of a multi-source power grid, as a plant comprising resistor-inductor impedance;
maintaining, associated with the feedback control algorithm, a two-dimensional operating space parameterized by voltage and frequency control variables associated with the multi-source power grid;
causing, using the feedback control algorithm, transitions between a plurality of operating modes of the one or more inverters by adjusting the voltage and frequency control variables according to grid conditions and power requirements of the multi-source power grid; and
ensuring stability of operation of the one or more inverters within the multi-source power grid through satisfaction of sector-boundedness conditions for nonlinear dynamics modeled within the feedback control algorithm.
